(19) United States
(12) Patent Application Publication
(10) Pub. No.: US 2015/0312581 A1
(43) Pub. Date: Oct. 29, 2015

(54) IMAGE PROCESSING DEVICE AND METHOD

(71) Applicant: SONY CORPORATION, Tokyo (JP)

(72) Inventor: Kazushi SATO, Kanagawa (JP)

(21) Appl. No.: 14/441,656

(22) PCT Filed: Dec. 16, 2013
(86) PCT No.: PCT/JP2013/083560

§ 371 Date: May 8, 2015

(30) Foreign Application Priority Data
Dec. 26, 2012 (JP) 2012-283615

(51) Int. Cl. H04N 19/33; H04N 19/105; H04N 19/70; H04N 19/187; H04N 19/593; H04N 19/31; H04N 19/182

(52) U.S. Cl. CPC H04N 19/33; H04N 19/31; H04N 19/105; H04N 19/182; H04N 19/187; H04N 19/593; H04N 19/70

(57) ABSTRACT

Provided is an image processing device including a receiving section configured to receive hierarchical image encoded data in which image data that is hierarchized into layers is encoded, a pixel filling section configured to fill, with a pixel of a base layer, an unavailable peripheral pixel positioned in a periphery of a current block that is used in intra prediction to he performed when an enhancement layer of the hierarchical image encoded data is decoded, an intra prediction section configured to perform intra prediction on the current block to generate a predictive image of the current block using the peripheral pixel that is filled with the pixel of the base layer by the pixel filling section when necessary, and a decoding section configured to decode the enhancement layer of the hierarchical image encoded data received by the receiving section using the predictive image generated by the intra prediction section.

### TECHNICAL FIELD

The present disclosure relates to an image processing device and method, and particularly relates to an image processing device and method which can suppress a decrease in encoding efficiency.

### BACKGROUND ART

Recently, devices for compressing and encoding an image by adopting a encoding scheme of handling image information digitally and performing compression by an orthogonal transform such as a discrete cosine transform and motion compensation using image information-specific redundancy for the purpose of information transmission and accumulation with high efficiency when the image information is handled digitally have become widespread. Moving Picture Experts Group (MPEG) and the like are examples of such encoding schemes.

Particularly, MPEG-2 (ISO/IEC 13818-2) is a standard which is defined as a generic image encoding scheme, covering both of interlaced scanning images and non-interlaced scanning images, and standard resolution images and high definition images. For example, MPEG-2 is used in a wide range of applications for professionals and consumers at present. When the MPEG-2 compression scheme is used, for example, a coding amount (bit rate) of 4 to 8 Mbps is allocated to an interlaced scanning image with standard resolution of 720×480 pixels. In addition, when the MPEG-2 compression scheme is used, for example, a coding amount (bit rate) of 18 to 22 Mbps is allocated to an interlaced scanning image with high resolution of 1920×1088 pixels. Accordingly, a high compression rate and satisfactory image quality can be realized.

MPEG-2 targeted coding for high image quality which is mostly appropriate for broadcasting; however, it had a lower coding amount (bit rate) than MPEG-1, i.e., failed to respond to an encoding scheme of a higher compression rate. With the spread of mobile terminals, needs for such encoding schemes were expected to increase from then on, and therefore standardization of an MPEG-4 encoding scheme was performed. With respect to an image encoding scheme, the standard was approved as an international standard of ISO/IEC 14496-2 in December 1998.

Furthermore, initially, for the purpose of image encoding for television conferences, standardization of H.26L (International Telecommunication Union Telecommunication Standardization Sector (ITU-T) Q6/16 Video Coding Expert Group (VCEG)) was performed a few years ago. It is known that, while H.26L requires a larger amount of arithmetic operations in encoding and decoding than in existing encoding schemes such as MPEG-2 or MPEG-4, it realizes higher encoding efficiency. In addition, as a part of activities of the present MPEG-4, on the basis of H.26L, the standardization for realizing higher encoding efficiency also with adaptation of functions that are not supported in H.26L has been performed as Joint Model of Enhanced-Compression Video Coding.

According to the schedule of the standardization, it became an international standard in the name of H.264 and MPEG-4 Part 10 (Advanced Video Coding; hereinafter denoted as AVC) in March 2003.

Furthermore, as an extension of H.264/AVC, the standardization of Fidelity Range Extensions (FRExt), which include encoding tools with profiles of RGB, 4:2:2, and 4:4:4 that are necessary for professional works, 8×8 DCT prescribed in the MPEG-2, and quantization matrixes, was completed in February 2005. Accordingly it had become an encoding scheme in which even film noise included in a video can be favorably expressed using H.264/AVC, and thus was used in a wide range of applications such as Blu-ray (a registered trademark) discs.

In recent years, however, needs for even higher compression rate encoding such as a desire to compress an image with about 4000×2000 pixels which is four times as many as a high-vision image, or a desire to distribute a high-vision image in an environment with a limited transmission capacity such as the Internet have been increasing. To this end, in the VCEG under the ITU-T described above, discussion of enhancement in encoding efficiency has continued.

Therefore, for the purpose of improving encoding efficiency compared to AVC, standardization of a encoding scheme referred to as high efficiency video coding (HEVC) by Joint Collaboration Team-Video Coding (JCTVC), which is a joint standardizing organization of International Telecommunication Union Telecommunication Standardization Sector (ITU-T) and International Organization for Standardization (ISO)/International Electrotechnical Commission (IEC), is currently in progress. With regard to the HEVC standard, a committee draft, the first, draft specification, has been issued in February, 2012 (for example, refer to Non-Patent Literature 1).

Meanwhile, the existing image encoding schemes such as MPEG-2 and AVC have a scalability function of dividing an image into a plurality of layers and encoding the plurality of layers.

In other words, for example, for a terminal having a low processing capability such as a mobile phone, image compression information of only a base layer is transmitted, and a moving image of low spatial and temporal resolutions or a low quality is reproduced, and for a terminal having a high processing capability such as a television or a personal computer, image compression information of an enhancement layer as well as a base layer is transmitted, and a moving image of high spatial and temporal resolutions or a high quality is reproduced. That is, image compression information according to a capability of a terminal or a network can be transmitted from a server without performing the transcoding process.

HEVC, however, prescribes intra prediction from which a predictive image is generated using a peripheral pixel that is a pixel in the periphery of a current block to be processed. As intra prediction, for example, angular prediction, planar prediction, and the like are prescribed therein. In addition, HEVC prescribes constrained intra prediction (constrained_intra_pred).

In the constrained intra prediction (constrained_intra_pred), when a current slice to be processed is inter-coded, a current block is intra-coded, and a peripheral block positioned in the periphery of the current block is inter-coded, intra prediction process is performed with a pixel of the peripheral block regarded as being unavailable.

However, since HEVC has adopted coding units (CU), some of peripheral pixels are considered to be unavailable in some cases. Thus, a pixel filling method for coping with such cases has been considered (for example, refer to Non-Patent Literature 2).

### CITATION LIST

### Non-Patent Literature

Non-Patent Literature 1: “High Efficiency Video Coding (HEVC) Text Specification Draft 9,” by Benjamin Bross, Woo-Jin Han, Jens-Rainer Ohm, Gary J. Sullivan, and Thomas Wiegand, JCTVC-H1003 v9, Joint Collaborative Team on Video Coding (JCT-VC) of ITU-T SG16 WP3 and ISO/IEC JTC1/SC29/WG11 11^{th} Meeting in Shanghai, CN, Oct. 10 to 19, 2012

Non-Patent Literature 2: “AHG16: Padding Process Simplification” by Xianglin Wang, Wei-Jung Chien, Marta Karczewicz, JCTVC-G812, Joint Collaborative Team on Video Coding (JCT-VC) of ITU-T SG16 WP3 and ISO/IEC JTC1/SC29/WG11 7^{th} Meeting in Geneva, Nov. 21 to 30, 2011

### SUMMARY OF INVENTION

### Technical Problem

However, there is concern in the method that, since a group of unavailable pixels is filled with the same pixel using zero-order order hold, prediction accuracy becomes low and encoding efficiency decreases.

The present disclosure takes the above circumstances into consideration, and aims to suppress a decrease in encoding efficiency.

### Solution to Problem

According to an aspect of the present technology, there is provided an image processing device including a receiving section configured to receive hierarchical image encoded data in which image data that is hierarchized into a plurality of layers is encoded, a pixel filling section configured to fill, with a pixel of a base layer, an unavailable peripheral pixel positioned in a periphery of a current block that is used in intra prediction to be performed when an enhancement layer of the hierarchical image encoded data is decoded, an intra prediction section configured to perform intra prediction on the current block to generate a predictive image of the current block using the peripheral pixel that is filled with the pixel of the base layer by the pixel filling section when necessary, and a decoding section configured to decode the enhancement layer of the hierarchical image encoded data received by the receiving section using the predictive image generated by the intra prediction section.

The pixel filling section can perform filling with a pixel of the base layer that is at a position corresponding to the unavailable peripheral pixel.

A determination section configured to determine availability of a peripheral pixel of the current block of the enhancement layer can be further included. When the determination section determines that there is an unavailable peripheral pixel, the pixel filling section can perform filling with the pixel of the base layer that is at the position corresponding to the unavailable peripheral pixel.

An up-sampling section configured to perform an up-sampling process on the pixel of the base layer according to a resolution ratio between the base layer and the enhancement layer can be further included. The pixel filling section can perform filling with the pixel of the base layer that has undergone the up-sampling process by the up-sampling section.

The receiving section can further receive constrained intra control information for controlling whether or not constrained intra is to be used. The pixel filling section can perform filling with the pixel only when the constrained intra is set to be used based on the constrained intra control information received by the receiving section.

The constrained intra control information can be transmitted in a picture parameter set (PPS).

The receiving section can further receive base layer pixel filling control information for controlling filling with the pixel of the base layer that is transmitted when the constrained intra is set to be used based on the constrained intra control information. The pixel filling section can perform filling with the pixel of the base layer when filling with the pixel of the base layer is allowed based on the base layer pixel filling control information that is received by the receiving section, and perform tilling with a pixel of the enhancement layer when filling with the pixel of the base layer is not allowed.

The base layer pixel filling control information can be transmitted in a picture parameter set (PPS).

The decoding section can further decode the base layer of the hierarchical image encoded data that is encoded in an encoding scheme different from an encoding scheme of the enhancement layer.

According to an aspect of the present technology, there is provided an image processing method including receiving hierarchical image encoded data in which image data that is hierarchized into a plurality of layers is encoded, filling, with a pixel of a base layer, an unavailable peripheral pixel positioned in a periphery of a current block that is used in intra prediction to he performed when an enhancement layer of the hierarchical image encoded data is decoded, performing intra prediction on the current block to generate a predictive image of the current block using the peripheral pixel that is filled with the pixel of the base layer when necessary, and decoding the enhancement layer of the received hierarchical image encoded data using the generated predictive image.

According to another aspect of the present technology, there is provided an image processing device including a pixel filling section configured to fill, with a pixel of a base layer, an unavailable peripheral pixel positioned in a periphery of a current block that is used in intra prediction to be performed when an enhancement layer of image data that is hierarchized into a plurality of layers is encoded, an intra prediction section configured to perform intra prediction on the current block to generate a predictive image of the current block using the peripheral pixel that is filled with the pixel of the base layer by the pixel filling section when necessary, an encoding section configured to encode the enhancement layer of the image data that is hierarchized into the plurality of layers using the predictive image generated by the intra prediction section, and a transmitting section configured to transmit hierarchical image encoded data obtained by the encoding section encoding the image data that is hierarchized into the plurality of layers.

The pixel filling section can perform filling with a pixel of the base layer that is at a position corresponding to the unavailable peripheral pixel.

A determination section configured to determine availability of a peripheral pixel of the current block of the enhancement layer can be further included. When the determination section determines that there is an unavailable peripheral pixel, the pixel filling section can perform filling with the pixel of the base layer that is at the position corresponding to the unavailable peripheral pixel.

An up-sampling section configured to perform an up-sampling process on the pixel of the base layer according to a resolution ratio between the base layer and the enhancement layer can be further included. The pixel filling section can perform filling with the pixel of the base layer that has undergone the up-sampling process by the up-sampling section.

A constrained intra control information setting section configured to set constrained intra control information for controlling whether or not constrained intra is to be used can be further included. The pixel filling section can perform filling with the pixel only when the constrained intra is set to be used based on the constrained intra control information set by the constrained intra control information setting section. The transmitting section can further transmit the constrained intra control information set by the constrained intra control information setting section.

The transmitting section can transmit the constrained intra control information in a picture parameter set (PPS).

A base layer pixel filling control information setting section configured to set base layer pixel filling control information for controlling filling with the pixel of the base layer when the constrained intra is set to be used based on the constrained intra control information can be further included. The pixel filling section can perform filling with the pixel of the base layer when filling with the pixel of the base layer is allowed based on the base layer pixel filling control information set by the base layer pixel filling control information setting section, and perform filling with a pixel of the enhancement layer when filling with the pixel of the base layer is not allowed. The transmitting section can further transmit the base layer pixel filling control information set by the base layer pixel filling control information setting section.

The transmitting section can transmit the base layer pixel filling control information in a picture parameter set (PPS).

The encoding section can further encode the base layer of the hierarchical image encoded data in an encoding scheme different from an encoding scheme of the enhancement layer.

According to another aspect of the present technology, there is provided an image processing method including filling, with a pixel of a base layer, an unavailable peripheral pixel positioned in a periphery of a current block that is used in intra prediction to be performed when an enhancement layer of image data that is hierarchized into a plurality of layers is encoded, performing intra prediction on the current block to generate a predictive image of the current block using the peripheral pixel that is filled with the pixel of the base layer when necessary, encoding the enhancement layer of the image data that is hierarchized into the plurality of layers using the generated predictive image, and transmitting hierarchical image encoded data obtained by encoding the image data that is hierarchized into the plurality of layers.

According to an aspect of the present technology, hierarchical image encoded data in which image data that is hierarchized into a plurality of layers is encoded is received, an unavailable peripheral pixel positioned in the periphery of a current block that is used in intra prediction to be performed when an enhancement layer of the hierarchical image encoded data is decoded is filled with a pixel of a base layer, intra prediction is performed on a current block to generate a predictive image of the current block using the peripheral pixel that is filled with the pixel of the base layer when necessary, and the enhancement layer of the received hierarchical image encoded data is decoded using the generated predictive image.

According to another aspect of the present technology, an unavailable peripheral pixel positioned in the periphery of a current block that is used in intra prediction to be performed when an enhancement layer of image data that is hierarchized into a plurality of layers is encoded is filled with a pixel of a base layer, intra prediction is performed on the current block to generate a predictive image of the current block using the peripheral pixel that is filled with the pixel of the base layer when necessary, the enhancement layer of the image data that is hierarchized into the plurality of layers is encoded using the generated predictive image, and hierarchized image encoded data obtained by encoding the image data that is hierarchized into the plurality of layers is transmitted.

### Advantageous Effects of Invention

According to the present disclosure, images can be encoded and decoded. Particularly, a decrease in encoding efficiency can be suppressed.

### BRIEF DESCRIPTION OF DRAWINGS

FIG. 1 is a diagram for describing an example of a configuration of a coding unit.

FIG. 2 is a diagram for describing an example of spatial scalable video coding.

FIG. 3 is a diagram for describing an example of temporal scalable video coding.

FIG. 4 is a diagram for describing an example of scalable video coding of a signal to noise ratio.

FIG. 5 is a diagram illustrating an example of syntax of a picture parameter set.

FIG. 6 is a continuation of the diagram from FIG. 5, illustrating the example of the syntax of the picture parameter set.

FIG. 7 is a diagram for describing an example of a state of filling of peripheral pixels in intra prediction.

FIG. 8 is a diagram for describing another example of a state of filling of peripheral pixels in intra prediction.

FIG. 9 is a diagram illustrating another example of syntax of a picture parameter set.

FIG. 10 is a continuation of the diagram from FIG. 9, illustrating the other example of the syntax of the picture parameter set.

FIG. 11 is a diagram illustrating an example of cropping.

FIG. 12 is a block diagram illustrating an example of a main configuration of a scalable encoding device.

FIG. 13 is a block diagram illustrating a main configuration example of a base layer image encoding section.

FIG. 14 is a block diagram illustrating an example of a main configuration of an enhancement layer image encoding section.

FIG. 15 is a block diagram illustrating a main configuration example of a pixel filling section.

FIG. 16 is a flowchart for describing an example of a flow of an encoding process.

FIG. 17 is a flow chart describing an example of the flow of a base layer encoding process.

FIG. 18 is a flow chart describing an example of the flow of a pixel filling control information setting process.

FIG. 19 is a flow chart describing an example of the flow of an enhancement layer encoding process.

FIG. 20 is a flow chart describing an example of the flow of an intra prediction process.

FIG. 21 is a block diagram illustrating an example of a main configuration of a scalable decoding device.

FIG. 22 is a block diagram illustrating a main configuration example of a base layer image decoding section.

FIG. 23 is a block diagram illustrating an example of a main configuration of an enhancement layer image decoding section.

FIG. 24 is a block diagram illustrating a main configuration example of another pixel tilling section.

FIG. 25 is a flow chart describing an example of the flow of a decoding process.

FIG. 26 is a flow chart describing an example of the flow of a base layer decoding process.

FIG. 27 is a flow chart describing an example of the flow of a pixel filling control information decoding process.

FIG. 28 is a flow chart describing an example of the flow of an enhancement layer decoding process.

FIG. 29 is a flow chart describing an example of the flow of a prediction process.

FIG. 30 is a flow chart describing an example of the flow of an intra prediction process.

FIG. 31 is a diagram illustrating an example of a hierarchical image encoding scheme.

FIG. 32 is a diagram illustrating an example of a multi-view image encoding scheme.

FIG. 33 is a block diagram illustrating an example of a main configuration of a computer.

FIG. 34 is a block diagram illustrating an example of a schematic configuration of a television device.

FIG. 35 is a block diagram illustrating an example of a schematic configuration of a mobile phone.

FIG. 36 is a block diagram illustrating an example of a schematic configuration of a recording/reproduction device.

FIG. 37 is a block diagram illustrating an example of a schematic configuration of an image capturing device.

FIG. 38 is a block diagram illustrating an example of using scalable video coding.

FIG. 39 is a block diagram illustrating another example of using scalable video coding.

FIG. 40 is a block diagram illustrating another example of using scalable video coding,

### DESCRIPTION OF EMBODIMENTS

Hereinafter, modes (hereinafter referred to as “embodiments”) for carrying out the present disclosure will be described. The description will proceed in the following order:

0. Overview

1. First embodiment (image encoding device)

2. Second embodiment (image decoding device)

3. Other

4. Third embodiment (computer)

5. Applications

6. Applications of scalable video coding

<0. Overview>

<Encoding Scheme>

Hereinafter, the present technology will be described in connection with an application to image encoding and decoding of a High Efficiency Video Coding (HEVC) scheme.

<Coding Unit>

In an Advanced Video Coding (AVC) scheme, a hierarchical structure based on a macroblock and a sub macroblock is defined. However, a macroblock of 16×16 pixels is not optimal for a large image frame such as a Ultra High Definition (UHD) (4000×2000 pixels) serving as a target of a next generation encoding scheme.

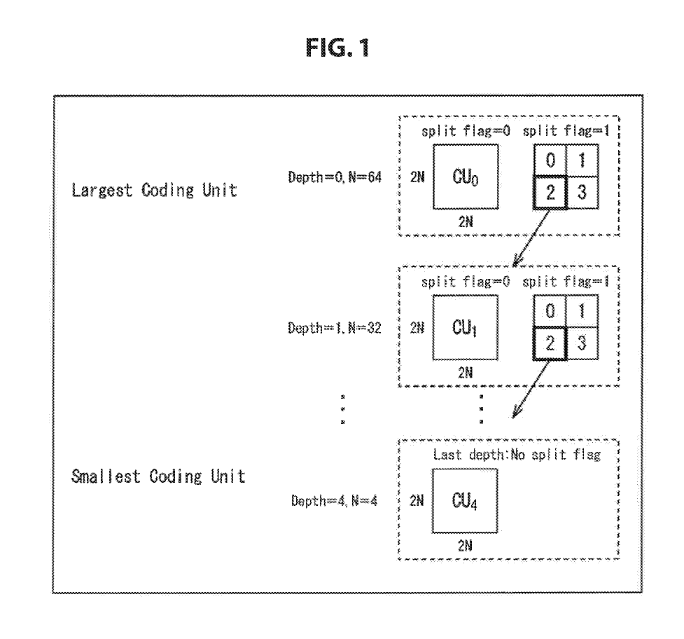

On the other hand, in the HEVC scheme, a coding unit (CU) is defined as illustrated in FIG. 1.

A CU is also referred to as a coding tree block (CTB), and serves as a partial area of an image of a picture unit undertaking the same role of a macroblock in the AVC scheme. The latter is fixed to a size of 16×16 pixels, but the former is not fixed to a certain size but designated in image compression information in each sequence.

For example, a largest coding unit (LCU) and a smallest coding unit (SCU) of a CU are specified in a sequence parameter set (SPS) included in encoded data to be output,

As split-flag=1 is set in a range in which each LCU is not smaller than an SCU, a coding unit can be divided into CUs having a smaller size. In the example of FIG. 1, a size of an LCU is 128, and a largest scalable depth is 5. A CU of a size of 2N×2N is divided into CUs having a size of N×N serving as a layer that is one-level lower when a value of split_flag is 1.

Further, a CU is divided in prediction units (PUs) that are areas (partial areas of an image of a picture unit) serving as processing units of intra or inter prediction, and divided into transform units (TUs) that are areas (partial areas of an image of a picture unit) serving as processing units of orthogonal transform. Currently, in the HEVC scheme, in addition to 4×4 and 8×8, orthogonal transform of 16×16 and 32×32 can be used.

As in the HEVC scheme, in the case of an encoding scheme in which a CU is defined and various kinds of processes are performed in units of CUs, in the AVC scheme, a macroblock can be considered to correspond to an LCU, and a block (sub block) can be considered to correspond to a CU. Further, in the AVC scheme, a motion compensation block can be considered to correspond to a PU. Here, since a CU has a hierarchical structure, a size of an LCU of a topmost layer is commonly set to be larger than a macroblock in the AVC scheme, for example, such as 128×128 pixels.

Thus, hereinafter, an LCU is assumed to include a macroblock in the AVC scheme, and a CU is assumed to include a block (sub block) in the AVC scheme. In other words, a “block” used in the following description indicates an arbitrary partial area in a picture, and, for example, a size, a shape, and characteristics thereof are not limited. In other words, a “block” includes an arbitrary area (a processing unit) such as a TU, a PU, an SCU, a CU, an LCU, a sub block, a macroblock, or a slice. Of course, a “block” includes other partial areas (processing units) as well. When it is necessary to limit a size, a processing unit, or the like, it will be appropriately described.

<Mode Selection>

Meanwhile, in the AVC and HEVC encoding schemes, in order to achieve high encoding efficiency, it is important to select an appropriate prediction mode.

As an example of such a selection method, there is a method implemented in reference software (found at http://iphome.hhi.de/suehring/tml/index.htm) of H.264/IMPEG-4 AVC called a joint model (JM).

In the JM, as will be described later, it is possible to select two mode determination methods, that is, a high complexity mode and a low complexity mode. In both modes, cost function values related to respective prediction modes are calculated, and a prediction mode having a smaller cost function value is selected as an optimal mode for a corresponding block or macroblock.

A cost function in the high complexity mode is represented as in the following Formula (1):

Cost(Mode∈Ω)=D+λ*R (1)

Here, Ω indicates a universal set of candidate modes for encoding a corresponding block or macroblock, and D indicates differential energy between a decoded image and an input image when encoding is performed in a corresponding prediction mode. λ indicates Lagrange's undetermined multiplier given as a function of a quantization parameter. R indicates a total coding amount including an orthogonal transform coefficient when encoding is performed in a corresponding mode.

In other words, in order to perform encoding in the high complexity mode, it is necessary to perform a temporary encoding process once by all candidate modes in order to calculate the parameters D and R, and thus a large computation amount is required.

A cost function in the low complexity mode is represented by the following Formula (2):

Cost(Mode∈Ω)=D+QP2Quant(QP)*HeaderBit (2)

Here, D is different from that of the high complexity mode and indicates differential energy between a prediction image and an input image. QP2Quant (QP) is given as a function of a quantization parameter QP, and HeaderBit indicates a coding amount related to information belonging to a header such as a motion vector or a mode including no orthogonal transform coefficient.

In other words, in the low complexity mode, it is necessary to perform a prediction process for respective candidate modes, but since a decoded image is not necessary, it is unnecessary to perform an encoding process. Thus, it is possible to implement a computation amount smaller than that in the high complexity mode.

<Scalable Video Coding>

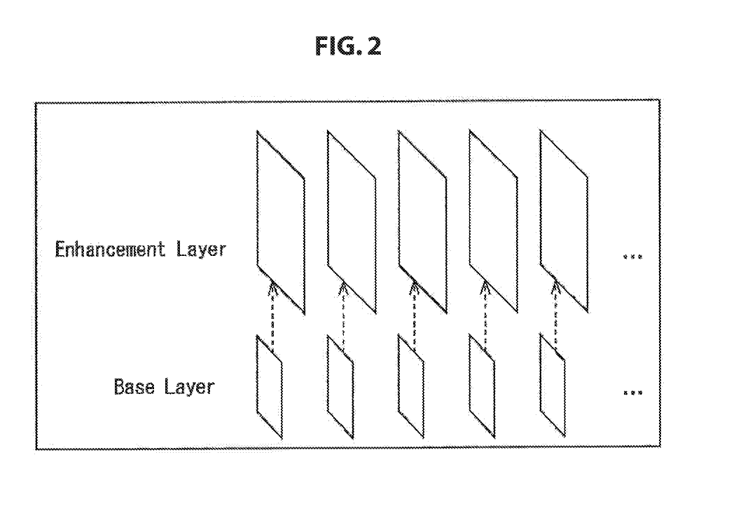

Meanwhile, the existing image encoding schemes such as MPEG-2 and AVC have a scalability function as illustrated in FIGS. 2 to 4. Scalable video coding refers to a scheme of dividing (hierarchizing) an image into a plurality of layers and performing encoding for each layer.

In hierarchization of an image, one image is divided into a plurality of images (layers) based on a certain parameter. Basically, each layer is configured with differential data so that redundancy is reduced. For example, when one image is hierarchized into two layers, that is, a base layer and an enhancement layer, an image of a lower quality than an original image is obtained using only data of the base layer, and an original image (that is, a high-quality image) is obtained by combining data of the base layer with data of the enhancement layer.

As an image is hierarchized as described above, it is possible to obtain images of various qualities according to the situation. For example, for a terminal having a low processing capability such as a mobile phone, image compression information of only a base layer is transmitted, and a moving image of low spatial and temporal resolutions or a low quality is reproduced, and for a terminal having a high processing capability such as a television or a personal computer, image compression information of an enhancement layer as well as a base layer is transmitted, and a moving image of high spatial and temporal resolutions or a high quality is reproduced. In other words, image compression information according to a capability of a terminal or a network can be transmitted from a server without performing the transcoding process.

As a parameter having scalability, for example, there is spatial resolution (spatial scalability) as illustrated in FIG. 2. When the spatial scalability differs, respective layers have different resolutions. In other words, each picture is hierarchized into two layers, that is, a base layer of a resolution spatially lower than that of an original image and an enhancement layer that is combined with an image of the base layer to obtain an original image (an original spatial resolution) as illustrated in FIG. 2. Of course, the number of layers is an example, and each picture can be hierarchized into an arbitrary number of layers.

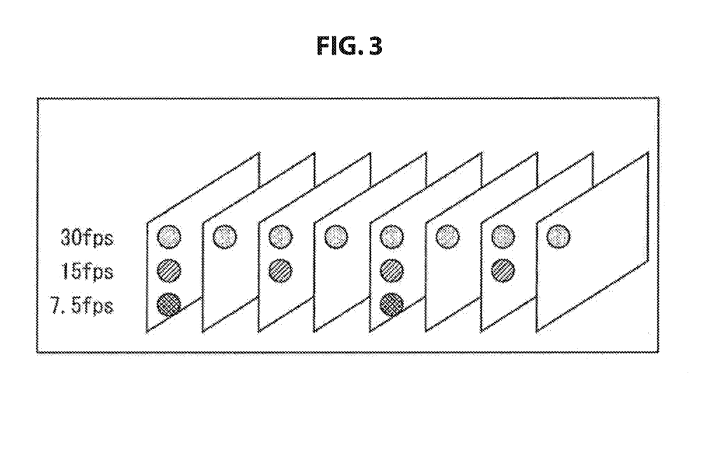

As another parameter having such scalability, for example, there is a temporal resolution (temporal scalability) as illustrated in FIG. 3. In the case of the temporal scalability, respective layers have different frame rates. In other words, in this case, each picture is hierarchized into layers having different frame rates, a moving image of a high frame rate can be obtained by combining a layer of a high frame rate with a layer of a low frame rate, and an original moving image (an original frame rate) can be obtained by combining all the layers as illustrated in FIG. 3. The number of layers is an example, and each picture can be hierarchized into an arbitrary number of layers.

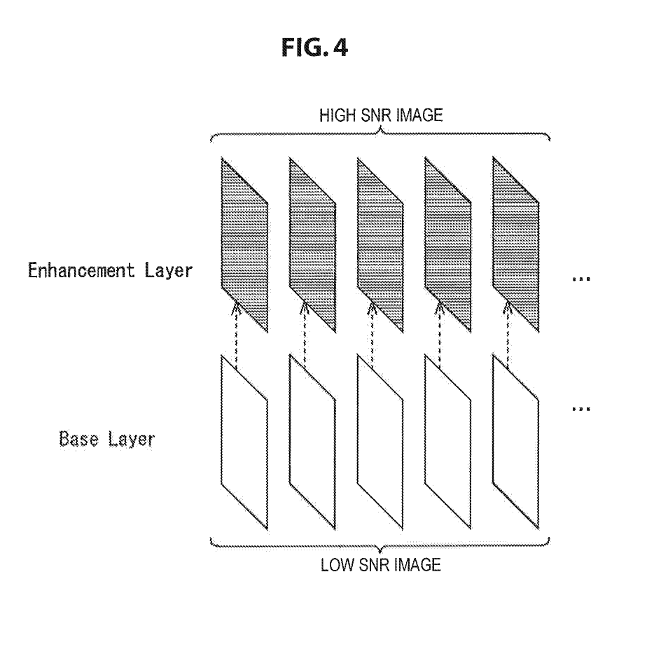

Further, as another parameter having such scalability, for example, there is a signal-to-noise ratio (SNR) (SNR scalability). In the case of the SNR scalability, respective layers having different SNRs. In other words, in this case, each picture is hierarchized into two layers, that is, a base layer of an SNR lower than that of an original image and an enhancement layer that is combined with an image of the base layer to obtain an original SNR as illustrated in FIG. 4. In other words, for base layer image compression information, information related to an image of a low PSNR is transmitted, and a high PSNR image can be reconstructed by combining the information with the enhancement layer image compression information. Of course, the number of layers is an example, and each picture can be hierarchized into an arbitrary number of layers.

A parameter other than the above-described examples may be applied as a parameter having scalability. For example, there is bit-depth scalability in which the base layer includes an 8-bit image, and a 10-bit image can be obtained by adding the enhancement layer to the base layer.

Further, there is chroma scalability in which the base layer includes a component image of a 4:2:0 format, and a component image of a 4:2:2 format can be obtained by adding the enhancement layer to the base layer.

<Filling of a Peripheral Pixel in Intra Prediction>

HEVC, however, prescribes intra prediction from which a predictive image is generated using a peripheral pixel that is a pixel in the periphery of a current block to be processed. As intra prediction, for example, angular prediction, planar prediction, and the like are prescribed.

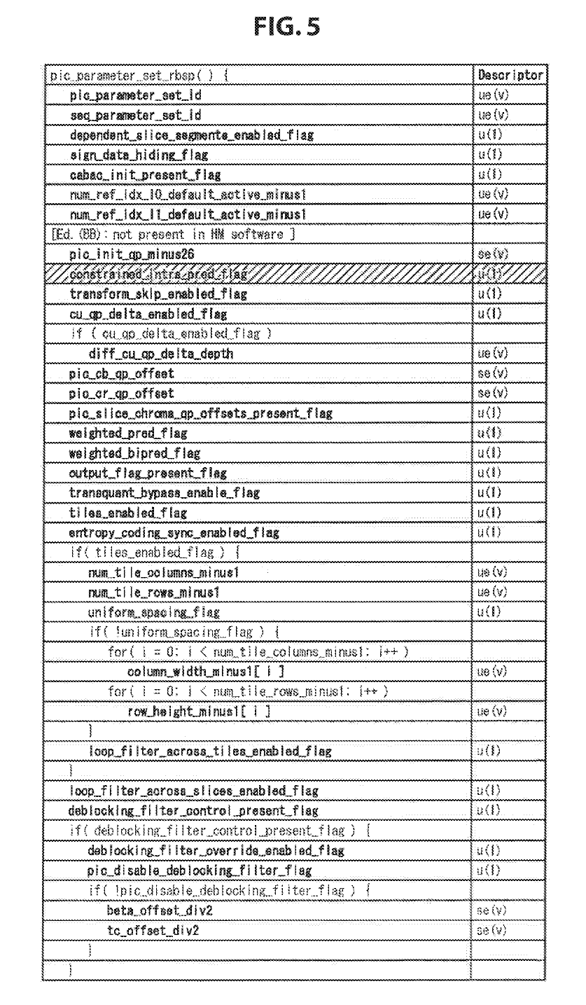

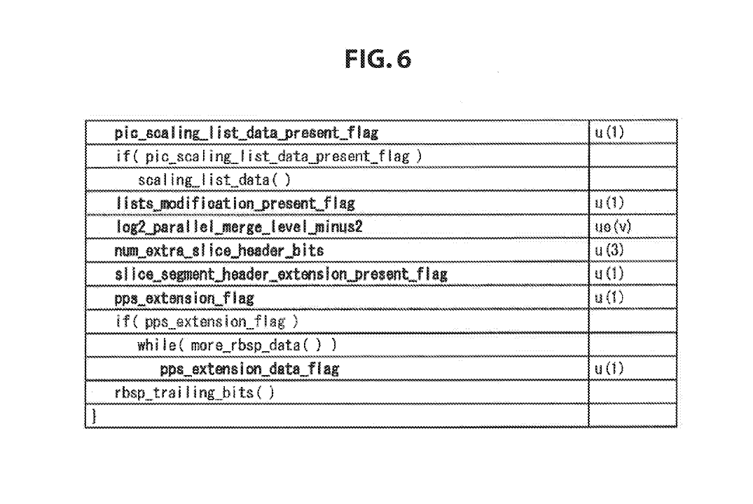

In addition, HEVC prescribes constrained_intra_pred_flag that is constrained intra control information for controlling whether or not constrained intra is to be used, like AVC. FIGS. 5 and 6 show an example of syntax of a picture parameter set (PPS) of HEVC. As shown in FIG. 5, the constrained intra control information (constrained_intra_pred_flag) is transmitted in the picture parameter set,

In other words, when the value of constrained_intra_pred_flag is “1,” and a current slice to be processed is inter-coded, a current block is intra-coded, and a peripheral block positioned in the periphery of the current block is inter-coded, an intra prediction process is performed with a pixel of the peripheral block regarded as being unavailable.

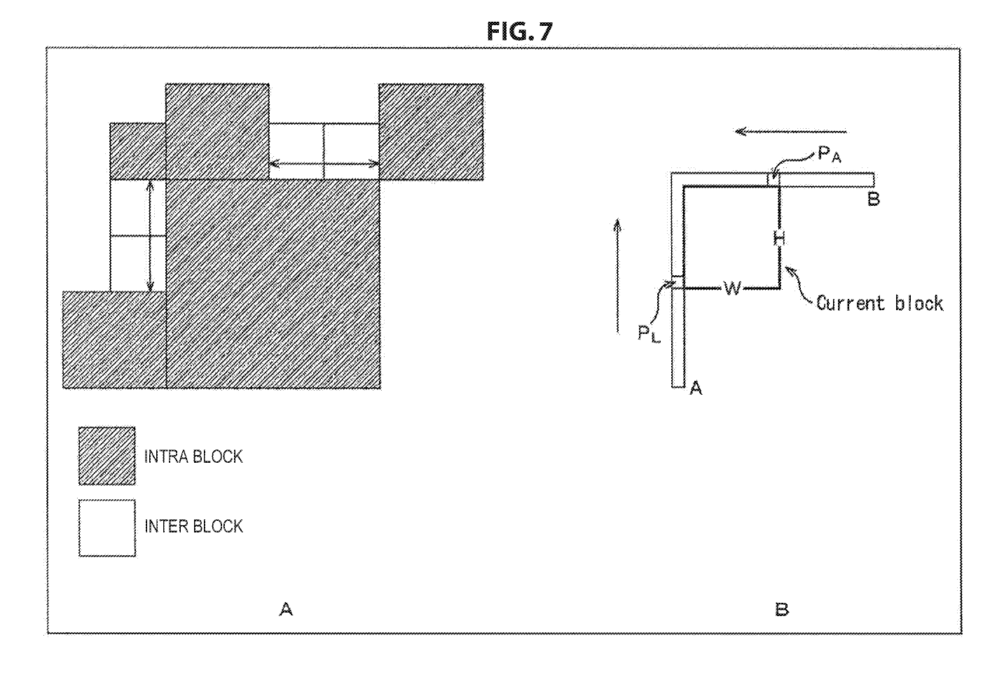

However, HEVC has adopted coding units as illustrated in FIG. 1. For this reason, when some peripheral pixels are unavailable as illustrated in A of FIG. 7, how these unavailable pixels are to be filled and thereby the intra prediction process is performed have been discussed, and accordingly, the process disclosed in Non-Patent Literature 2 has been prescribed.

In other words, a search (scanning) begins in the directions of the arrows from pixels A and B to detect pixels on the boundaries of unavailable (which will also be referred to as “not available”) and available regions as illustrated in B of FIG. 7. When an end is not available, it is assumed that there is an available pixel which satisfies (1<<(BitDepthY 1)).

The pixel of the region that is not available is filled with the value of the final pixel of the available region.

The pixel filling process is performed in one direction, and not retraced.

In such a process, however, since the same pixel fills positions that are not available using zero-order order hold, there is concern of encoding efficiency decreasing.

<Filling with a Pixel of a Base Layer>

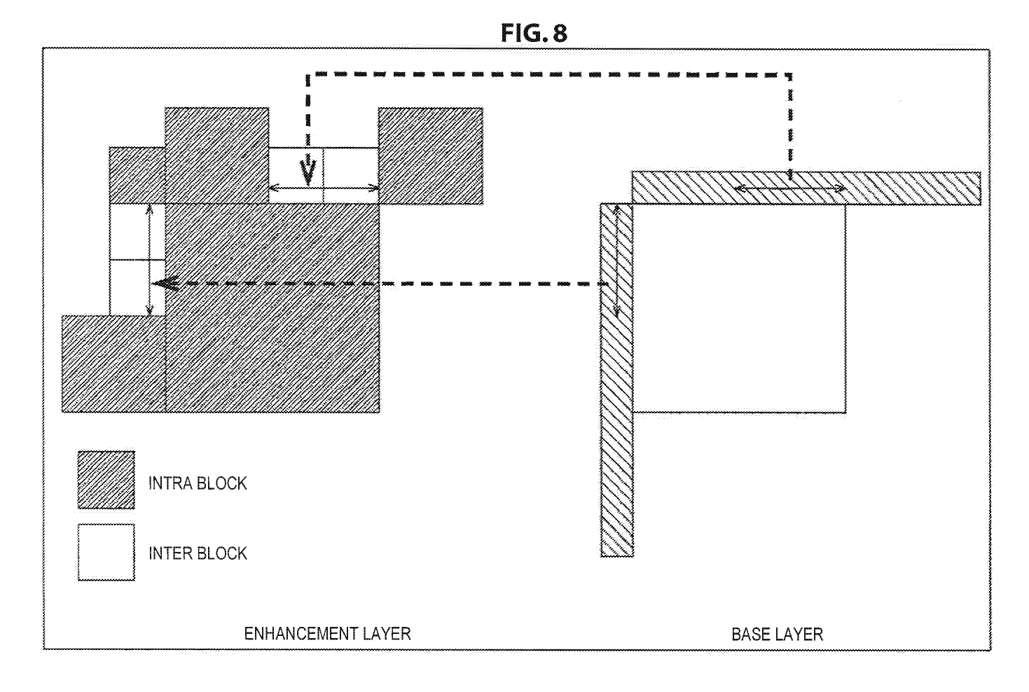

Thus, in intra prediction of encoding and decoding of an enhancement layer, using a high degree of correlation between pixel values of layers (for example, a base layer and the enhancement layer) in scalable encoding, a filling process is performed on a peripheral pixel that is unavailable due to the fact that the value of constrained_intra_pred_flag which is constrained intra control information for controlling whether or not constrained intra is to be used is “1” using the pixel value of the corresponding base layer as illustrated in FIG. 8.

Thus, a pixel value having a higher correlation can be filled and prediction accuracy can be enhanced. Therefore, a decrease in encoding efficiency can be suppressed and image quality of a decoded image can improve.

Note that, when an encoding process which uses a spatial scalability which has a scalability in a space direction such as resolution is performed, a decoded image of a base layer may be set to undergo up-sampling (a conversion process (enlargement or reduction)) according to the scalable ratio between layers so as to be used in a filling process.

In addition, in order to reduce unnecessary access to a memory which stores a decoded image of the base layer, base layer pixel filling control information (fill_with_baselayer_pixel_flag) for controlling filling with a pixel of the base layer may be set and transmitted.

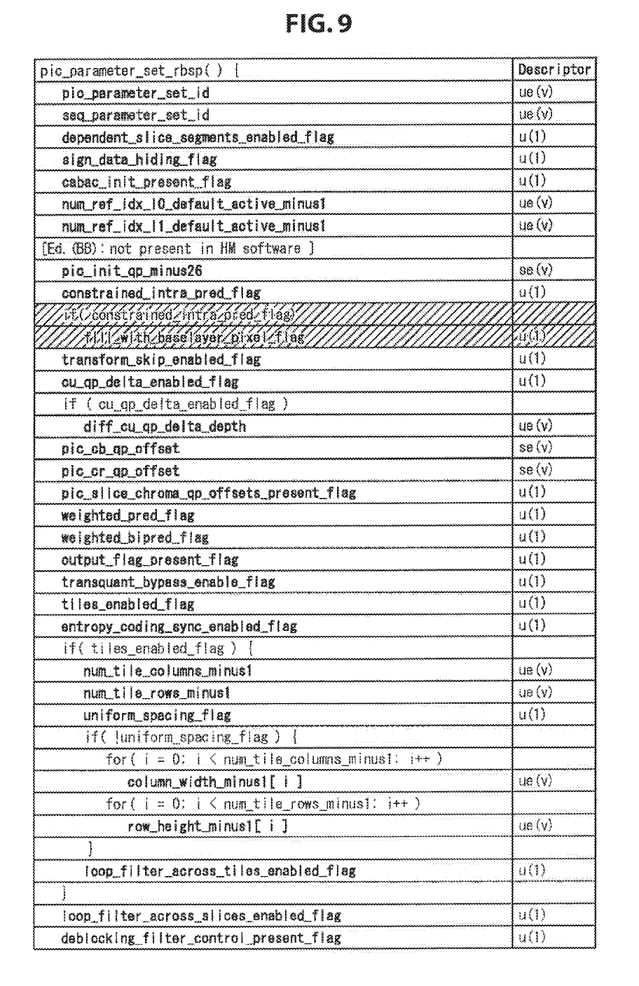

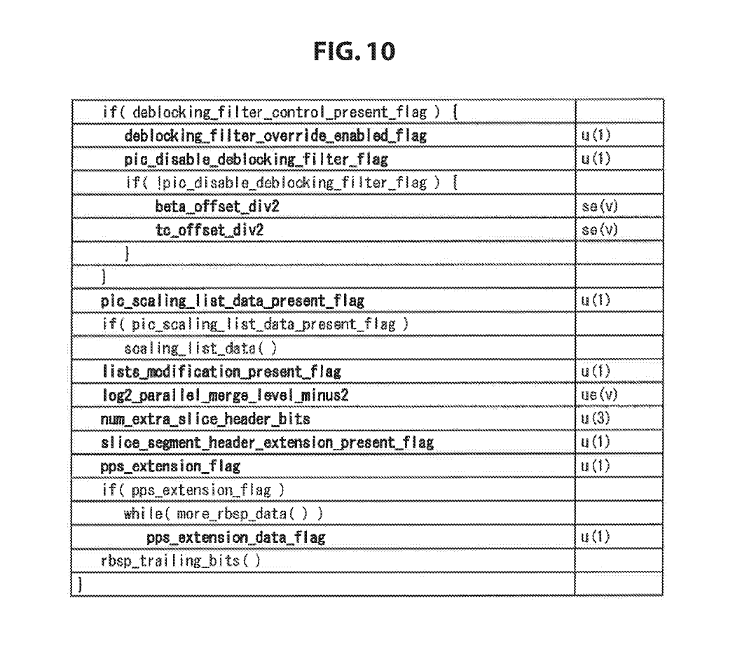

This fill_with_baselayer_pixel_flag that is base layer pixel filling control information may be transmitted in, for example, a picture parameter set (PPS). In addition, this base layer pixel filling control information (fill_with_baselayer_pixel_flag) may be transmitted only when the value of constrained intra control information (constrained_intra_pred_flag) of an enhancement layer is “1.” An example of syntax of a picture parameter set of that case is shown in FIGS. 9 and 10.

In other words, when the value of constrained_intra_pred_flag is “1,” fill_with_baselayer_flag is transmitted. When the value thereof is “1,” an unavailable pixel of the enhancement layer is filled with the pixel value of the base layer. Note that, for the base layer, fill_with_baselayer_flag is not transmitted. Alternatively, even if it is transmitted, it is not used in a decoding process.

By applying the present technology described above, a decrease in encoding efficiency can be suppressed even when the value of constrained_intra_pred_flag is “1” in intra prediction of encoding and decoding of the enhancement layer in scalable encoding and decoding.

Note that the present technology described above can also be applied to a case in which an image of a base layer is encoded and decoded using a method other than HEVC, for example, AVC, MPEG-2, or the like.

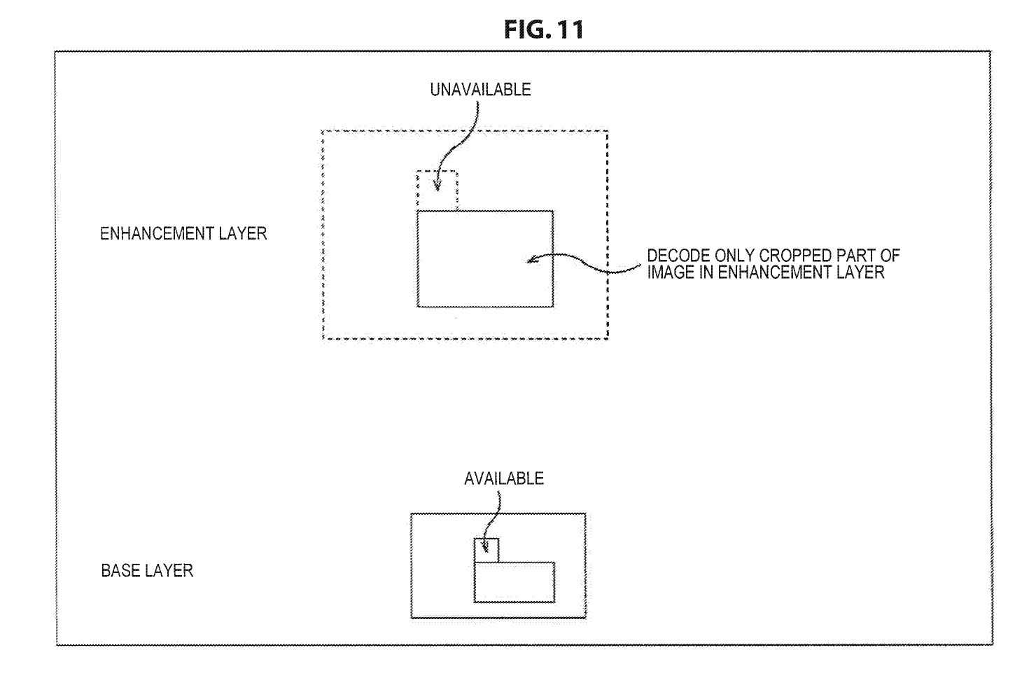

In addition, in a case of hierarchical encoding and hierarchical decoding in which hierarchized image data is encoded and decoded (scalable encoding and scalable decoding), a part of an entire image can be cropped (cropping) for encoding in an enhancement layer. When such cropping is performed, a peripheral pixel that is available in the base layer is also considered to become unavailable in the enhancement layer as illustrated in FIG. 11. The present technology can also be applied to this case.

Next, application examples of the present technology described above to specific devices will be described.

### 1. First Embodiment

<Scalable Encoding Device>

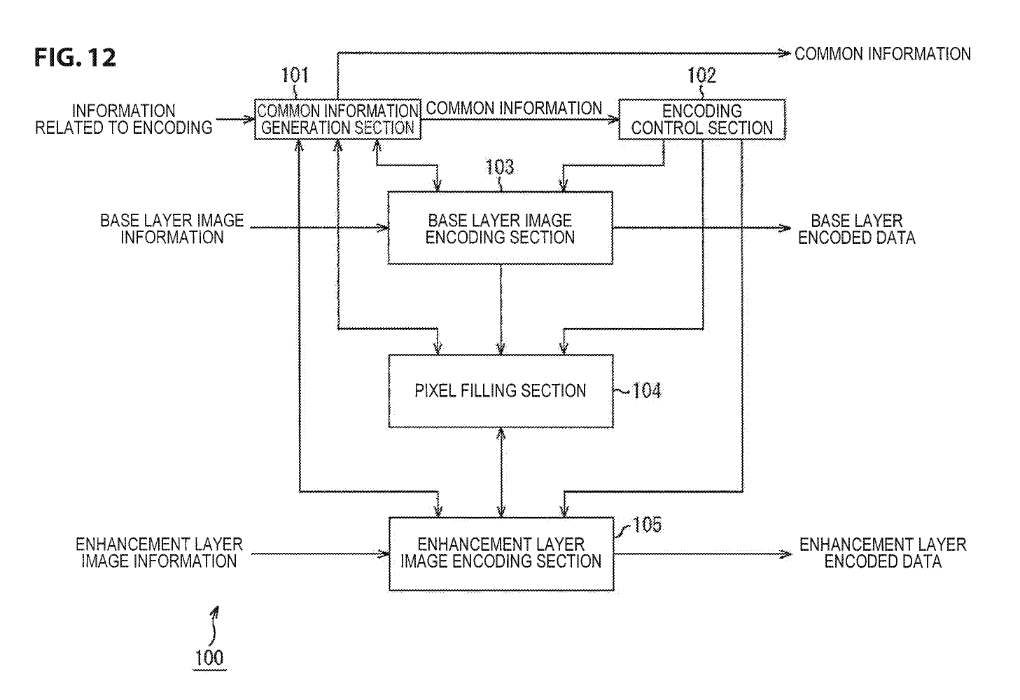

FIG. 12 is a block diagram illustrating a main configuration example of a scalable encoding device.

The scalable encoding device 100 illustrated in FIG. 12 is an image information processing device which performs scalable encoding on image data, and encodes each layer of image data hierarchized into a base layer and an enhancement layer. A parameter used as a reference of the hierarchization (a parameter that brings scalability) is arbitrary. The scalable encoding device 100 has a common information generation section 101, an encoding control section 102, a base layer image encoding section 103, a pixel filling section 104, and an enhancement layer image encoding section 105.

The common information generation section 101 acquires information related to encoding of image data that is, for example, stored in an NAL unit. In addition, the common information generation section 101 acquires necessary information from the base layer image encoding section 103, the pixel filling section 104, the enhancement layer image encoding section 105, and the like when necessary. The common information generation section 101 generates common information that is information related to all layers on the basis of the aforementioned information, Common information includes, for example, a video parameter set, and the like. The common information generation section 101 outputs the generated common information to the outside of the scalable encoding device 100 as, for example, an NAL unit. Note that the common information generation section 101 also supplies the generated common information to the encoding control section 102. Furthermore, the common information generation section 101 also supplies part or all of the generated common information to the base layer image encoding section 103 to the enhancement layer image encoding section 105 when necessary.

The encoding control section 102 controls the base layer image encoding section 103 to the enhancement layer image encoding section 105 based on the common information supplied from the common information generation section 101 to control encoding of each layer.

The base layer image encoding section 103 acquires image information of the base layer (base layer image information). The base layer image encoding section 103 encodes the base layer image information without using information of other layers, generates encoded data of the base layer (base layer encoded data), and outputs the data. In addition, the base layer image encoding section 103 supplies a decoded image of the base layer obtained in the encoding to the pixel filling section 104.

The pixel filling section 104 performs a process related to filling of a peripheral pixel when constrained intra is used in intra prediction to be performed in the enhancement layer image encoding section 105. For example, the pixel filling section 104 acquires a decoded image of the base layer from the base layer image encoding section 103 and fills an unavailable peripheral pixel of the enhancement layer with a pixel of the base layer. The pixel tilling section 104 supplies the filling pixel of the peripheral pixel to the enhancement layer image encoding section 105.

The enhancement layer image encoding section 105 acquires image information of the enhancement layer (enhancement layer image information). The enhancement layer image encoding section 105 encodes the enhancement layer image information. Note that, at the time of intra prediction of a current block, the enhancement layer image encoding section 105 supplies a peripheral pixel of the current block to the pixel filling section 104. In addition, the enhancement layer image encoding section 105 acquires the filling pixel of the peripheral pixel of the current block from the pixel filling section 104. The enhancement layer image encoding section 105 performs intra prediction using the filling pixel and encodes the image of the enhancement layer. Then, the enhancement layer image encoding section 105 outputs obtained encoded data (enhancement layer encoded data).

<Base Layer Image Encoding Section>

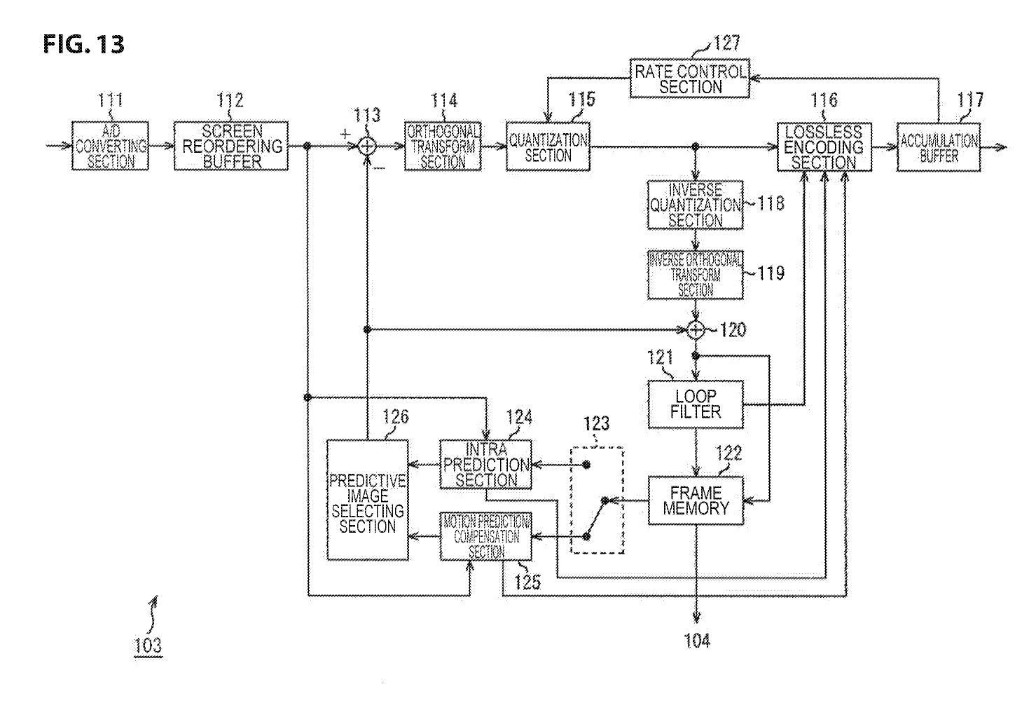

FIG. 13 is a block diagram illustrating an example of a main configuration of the base layer image encoding section 103 of FIG. 12. As illustrated in FIG. 13, the base layer image encoding section 103 includes an A/D converting section 111, a screen reordering buffer 112, an operation section 113, an orthogonal transform section 114, a quantization section 115, a lossless encoding section 116, an accumulation buffer 117, an inverse quantization section 118, and an inverse orthogonal transform section 119. The base layer image encoding section 103 further includes an operation section 120, a loop filter 121, a frame memory 122, a selecting section 123, an intra prediction section 124, a motion prediction/compensation section 125, a predictive image selecting section 126, and a rate control section 127.

The A/D converting section 111 performs A/D conversion on input image data (the base layer image information), and supplies the converted image data (digital data) to be stored in the screen reordering buffer 112. The screen reordering buffer 112 reorders images of frames stored in a display order in a frame order for encoding according to a Group Of Pictures (GOP), and supplies the images in which the frame order is reordered to the operation section 113. The screen reordering buffer 112 also supplies the images in which the frame order is reordered to the intra prediction section 124 and the motion prediction/compensation section 125.

The operation section 113 subtracts a predictive image supplied from the intra prediction section 124 or the motion prediction/compensation section 125 via the predictive image selecting section 126 from an image read from the screen reordering buffer 112, and outputs differential information thereof to the orthogonal transform section 114. For example, in the case of an image that has been subjected to intra coding, the operation section 113 subtracts the predictive image supplied from the intra prediction section 124 from the image read from the screen reordering buffer 112. Further, for example, in the case of an image that has been subjected to inter coding, the operation section 113 subtracts the predictive image supplied from the motion prediction/compensation section 125 from the image read from the screen. reordering buffer 112.

The orthogonal transform section 114 performs an orthogonal transform such as a discrete cosine transform or a Karhunen-Loève Transform on the differential information supplied from the operation section 113. The orthogonal transform section 114 supplies transform coefficients to the quantization section 115.

The quantization section 115 quantizes the transform coefficients supplied from the orthogonal transform section 114. The quantization section 115 sets a quantization parameter based on information related to a target value of a coding amount supplied from the rate control section 127, and performs the quantizing. The quantization section 115 supplies the quantized transform coefficients to the lossless encoding section 116.

The lossless encoding section 116 encodes the transform coefficients quantized in the quantization section 115 according to an arbitrary encoding scheme. Since coefficient data is quantized under control of the rate control section 127, the coding amount becomes a target value (or approaches a target value) set by the rate control section 127.

The lossless encoding section 116 acquires information indicating an intra prediction mode or the like from the intra prediction section 124, and acquires information indicating an inter prediction mode, differential motion vector information, or the like from the motion prediction/compensation section 125. Further, the lossless encoding section 116 appropriately generates an NAL unit of the base layer including a sequence parameter set (SPS), a picture parameter set (PPS), and the like.

The lossless encoding section 116 encodes various kinds of information according to an arbitrary encoding scheme, and sets (multiplexes) the encoded information as part of encoded data (also referred to as an “encoded stream”). The lossless encoding section 116 supplies the encoded data obtained by the encoding to be accumulated in the accumulation buffer 117.

Examples of the encoding scheme of the lossless encoding section 116 include variable length coding and arithmetic coding. As the variable length coding, for example, there is Context-Adaptive Variable Length Coding (CAVLC) defined in the H.264/AVC scheme, As the arithmetic coding, for example, there is Context-Adaptive Binary Arithmetic Coding (CABAC).

The accumulation buffer 117 temporarily holds the encoded data (base layer encoded data) supplied from the lossless encoding section 116. The accumulation buffer 117 outputs the held base layer encoded data to a recording device (recording medium), a transmission path, or the like (not illustrated) at a subsequent stage at a certain timing. In other words, the accumulation buffer 117 serves as a transmitting section that transmits the encoded data as well.

The transform coefficients quantized by the quantization section 115 are also supplied to the inverse quantization section 118. The inverse quantization section 118 inversely quantizes the quantized transform coefficients according to a method corresponding to the quantization performed by the quantization section 115. The inverse quantization section 118 supplies the obtained transform coefficients to the inverse orthogonal transform section 119.

The inverse orthogonal transform section 119 performs an inverse orthogonal transform on the transform coefficients supplied from the inverse quantization section 118 according to a method corresponding to the orthogonal transform process performed by the orthogonal transform section 114. An output (restored differential information) that has been subjected to the inverse orthogonal transform is supplied to the operation section 120.

The operation section 120 obtains a locally decoded image (a decoded image) by adding the predictive image supplied from the intra prediction section 124 or the motion prediction/compensation section 125 via the predictive image selecting section 126 to the restored differential information serving as an inverse orthogonal transform result supplied from the inverse orthogonal transform section 119. The decoded image is supplied to the loop filter 121 or the frame memory 122.

The loop filter 121 includes a deblock filter, an adaptive loop filter, or the like, and appropriately performs a filter process on the reconstructed image supplied from the operation section 120. For example, the loop filter 121 performs the deblock filter process on the reconstructed image, and removes block distortion of the reconstructed image. Further, for example, the loop filter 121 improves the image quality by performing the loop filter process on the deblock filter process result (the reconstructed image from which the block distortion has been removed) using a Wiener filter. The loop filter 121 supplies the filter process result (hereinafter referred to as a “decoded image”) to the frame memory 122.

The loop filter 121 may further perform any other arbitrary filter process on the reconstructed image. The loop filter 121 may supply information used in the filter process such as a filter coefficient to the lossless encoding section 116 as necessary so that the information can be encoded.

The frame memory 122 stores the reconstructed image supplied from the operation section 120 and the decoded image supplied from the loop filter 121. The frame memory 122 supplies the stored reconstructed image to the intra prediction section 124 via the selecting section 123 at a certain timing or based on an external request, for example, from the intra prediction section 124. Further, the frame memory 122 supplies the stored decoded image to the motion prediction/compensation section 125 via the selecting section 123 at a certain timing or based on an external request, for example, from the motion prediction/compensation section 125.

The frame memory 122 stores the supplied decoded image, and supplies the stored decoded image to the selecting section 123 as a reference image at a certain timing.

The selecting section 123 selects a supply destination of the reference image supplied from the frame memory 122. For example, in the case of the intra prediction, the selecting section 123 supplies the reference image (a pixel value of a current picture) supplied from the frame memory 122 to the motion prediction/compensation section 125. Further, for example, in the case of the inter prediction, the selecting section 123 supplies the reference image supplied from the frame memory 122 to the motion prediction/compensation section 125.

The intra prediction section 124 performs the intra prediction (intra-screen prediction) for generating the predictive image using the pixel value of the current picture serving as the reference image supplied from the frame memory 122 via the selecting section 123. The intra prediction section 124 performs the intra prediction in a plurality of intra prediction modes that are prepared in advance.

The intra prediction section 124 generates predictive images in all the intra prediction modes serving as the candidates, evaluates cost function values of the predictive images using the input image supplied from the screen reordering buffer 112, and selects an optimal mode. When the optimal intra prediction mode is selected, the intra prediction section 124 supplies the predictive image generated in the optimal mode to the predictive image selecting section 126.

As described above, the intra prediction section 124 appropriately supplies, for example, the intra prediction mode information indicating the employed intra prediction mode to the lossless encoding section 116 so that the information is encoded.

The motion prediction/compensation section 125 performs the motion prediction (the inter prediction) using the input image supplied from the screen reordering buffer 112 and the reference image supplied from the frame memory 122 via the selecting section 123. The motion prediction/compensation section 125 performs a motion compensation process according to a detected motion vector, and generates a predictive image (inter-predictive image information). The motion prediction/compensation section 125 performs the inter prediction in a plurality of inter prediction modes that are prepared in advance.

The motion prediction/compensation section 125 generates predictive images in all the inter prediction modes serving as a candidate. The motion prediction/compensation section 125 evaluates cost function values of the predictive images using the input image supplied from the screen reordering buffer 112, information of the generated differential motion vector, and the like, and selects an optimal mode. When the optimal inter prediction mode is selected, the motion prediction/compensation section 125 supplies the predictive image generated in the optimal mode to the predictive image selecting section 126.

The motion prediction/compensation section 125 supplies information indicating the employed inter prediction mode, information necessary for performing processing in the inter prediction mode when the encoded data is decoded, and the like to the lossless encoding section 116 so that the information is encoded. For example, as the necessary information, there is information of a generated differential motion vector, and as prediction motion vector information, there is a flag indicating an index of a prediction motion vector.

The predictive image selecting section 126 selects a supply source of the prediction image to be supplied to the operation section 113 and the operation section 120. For example, in the case of the intra coding, the predictive image selecting section 126 selects the intra prediction section 124 as the supply source of the predictive image, and supplies the predictive image supplied from the intra prediction section 124 to the operation section 113 and the operation section 120. For example, in the case of the inter coding, the predictive image selecting section 126 selects the motion prediction/compensation section 125 as the supply source of the predictive image, and supplies the predictive image supplied from the motion prediction/compensation section 125 to the operation section 113 and the operation section 120.

The rate control section 127 controls a rate of a quantization operation of the quantization section 115 based on the coding amount of the encoded data accumulated in the accumulation buffer 117 such that no overflow or underflow occurs.

Note that the frame memory 122 supplies a stored decoded image (base layer decoded image) to the pixel filling section 104.

<Enhancement Layer Image Encoding Section>

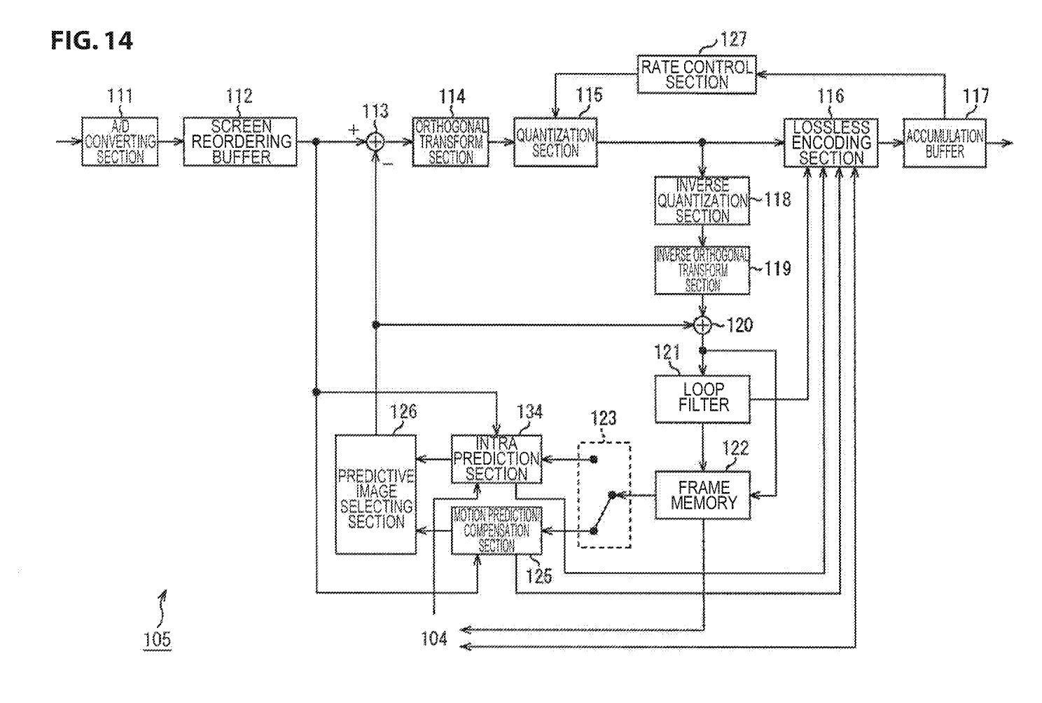

FIG. 14 is a block diagram illustrating a main configuration example of the enhancement layer image encoding section 105 of FIG. 12. As illustrated in FIG. 14, the enhancement layer image encoding section 105 basically has the same configuration as the base layer image encoding section 103 of FIG. 13.

Each section of the enhancement layer image encoding section 105, however, performs a process related to encoding of enhancement layer image information, rather than the base layer. In other words, the A/D converting section 111 of the enhancement layer image encoding section 105 performs A/D conversion on enhancement layer image information, and the accumulation buffer 117 of the enhancement layer image encoding section 105 outputs enhancement layer encoded data to, for example, a recording device (recording medium) provided in the later stage not illustrated, a transmission path, or the like.

In addition, the enhancement layer image encoding section 105 has an intra prediction section 134, instead of the intra prediction section 124.

The intra prediction section 134 acquires a filling pixel generated by the pixel filling section 104, performs intra prediction on the enhancement layer using a peripheral pixel of a current block tilled with the filling pixel, and thereby generates a predictive image. The intra prediction is performed in the same manner as in the intra prediction section 124.

Like the intra prediction section 124, the intra prediction section 134 appropriately supplies, for example, the intra prediction mode information indicating the employed intra prediction mode to the lossless encoding section 116 so that the information is encoded.

Note that the frame memory 122 supplies a stored decoded image (enhancement layer decoded image) to the pixel filling section 104. In addition, the lossless encoding section 116 supplies information related to the resolution of the enhancement layer and the like to the pixel filling section 104. Furthermore, the lossless encoding section 116 acquires information such as constrained intra control information constrained_intra_pred_flag) supplied from the pixel filling section 104, base layer pixel filling control information (fill_with_baselayer_pixel_flag), and the like, encodes the information, and causes it to be transmitted to the decoding side as, for example, a picture parameter set.

<Pixel Filling Section>

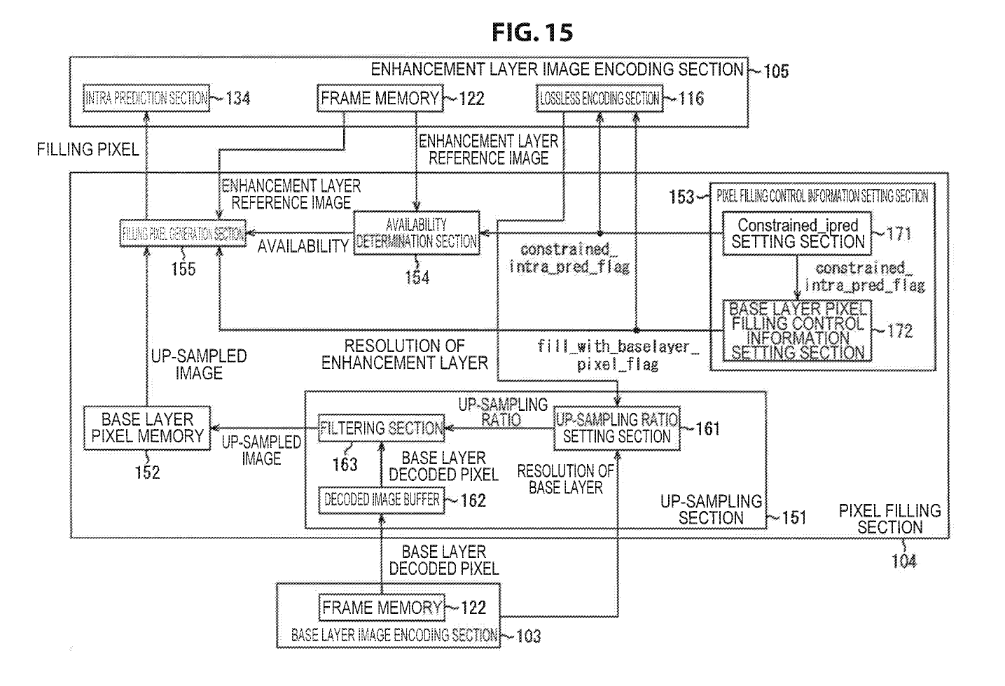

FIG. 15 is a block diagram illustrating a main configuration example of the pixel filling section 104 of FIG. 12.

As illustrated in FIG. 15, the pixel filling section 104 has an up-sampling section 151, a base layer pixel memory 152, a pixel filling control information setting section 153, an availability determination section 154, and a filling pixel generation section 155.

The up-sampling section 151 performs an up-sampling process (conversion process) of a baser layer decoded image. As illustrated in FIG. 15, the up-sampling section 151 has an up-sampling ratio setting section 161, a decoded image buffer 162, and a filtering section 163.

The up-sampling ratio setting section 161 sets a conversion ratio of an up-sampling process of the base layer decoded image (which will also be referred to as an up-sampling ratio). The up-sampling ratio setting section 161 acquires the resolution of the enhancement layer from, for example, the lossless encoding section 116 of the enhancement layer image encoding section 105. In addition, the up-sampling ratio setting section 161 acquires the resolution of the base layer from the base layer image encoding section 103 (for example, the lossless encoding section 116, or the like). The up-sampling ratio setting section 161 sets an up-sampling ratio based on the information. In other words, the up-sampling ratio setting section 161 can set an up-sampling ratio according to the resolution ratio between the base layer and the enhancement layer. Accordingly, the up-sampling section 151 can perform an up-sampling process on the base layer decoded image at the ratio according to the resolution ratio between the base layer and the enhancement layer. The up-sampling ratio setting section 161 supplies the set up-sampling ratio to the filtering section 163.

The decoded image buffer 162 stores the base layer decoded image supplied from the frame memory 122 of the base layer image encoding section 103. The decoded image buffer 162 supplies the stored base layer decoded image to the filtering section 163.

The filtering section 163 performs the up-sampling process on the base layer decoded image read from the decoded image buffer 162 at the up-sampling ratio supplied from the up-sampling ratio setting section 161. The filtering section 163 supplies the up-sampling-processed base layer decoded image (which will also be referred to as an up-sampled image) to the base layer pixel memory 152.

The base layer pixel memory 152 stores the up-sampled image supplied from the filtering section 163. The base layer pixel memory 152 supplies the stored up-sampled image to the filling pixel generation section 155.

The pixel filling control information setting section 153 sets control information related to filling of a pixel. As illustrated in FIG. 15, the pixel filling control information setting section 153 has a Constrained_ipred setting section 171 and a base layer pixel filling control information setting section 172.

The Constrained_ipred setting section 171 sets constrained_intra_pred_flag that is constrained intra control information for controlling whether or not constrained intra is to be used. This setting of the constrained intra control information may be performed arbitrarily. For example, the Constrained_ipred setting section 171 may set constrained intra control information according to an instruction from the outside, such as from a user.

The Constrained_ipred setting section 171 supplies the set constrained intra control information (constrained_intra_pred_flag) to the base layer pixel filling control information setting section 172. In addition, the Constrained_ipred setting section 171 also supplies the set constrained intra control information (constrained_intra_pred_flag) to the availability determination section 154. Furthermore, the Constrained_ipred setting section 171 also supplies the set constrained intra control information (constrained_intra_pred_flag) to the lossless encoding section 116 of the enhancement layer image encoding section 105 and causes the information to be transmitted to the decoding side. As described above, the lossless encoding section 116 of the enhancement layer image encoding section 105 encodes the constrained intra control information (constrained_intra_pred_flag) supplied as above, and causes the information to be transmitted on the decoding side in, for example, a picture parameter set (PPS) or the like.

When the value of the constrained intra control information (constrained_intra_pred_flag) supplied from the Constrained_ipred setting section 171 is “1,” the base layer pixel filling control information setting section 172 sets base layer pixel filling control information (fill_with_baselayer_pixel_flag) for controlling filling with a pixel of the base layer. The base layer pixel filling control information setting section 172 supplies the set base layer pixel filling control information (fill_with_baselayer_pixel_flag) to the filling pixel generation section 155. In addition, the base layer pixel filling control information setting section 172 also supplies the base layer pixel filling control information (fill_with_baselayer_pixel_flag) to the lossless encoding section 116 of the enhancement layer image encoding section 105, and causes the information to be transmitted to the decoding side. As described above, the lossless encoding section 116 of the enhancement layer image encoding section 105 encodes the base layer pixel filling control information (fill_with_baselayer_pixel_flag) supplied as above, and causes the information to be transmitted to the decoding side in, for example, a picture parameter set (PPS), or the like.

When the value of the constrained intra control information (constrained_intra_pred_flag) supplied from the Constrained_ipred setting section 171 is “1,” the availability determination section 154 acquires an enhancement layer reference image from the frame memory 122 of the enhancement layer image encoding section 105. The enhancement layer reference image includes peripheral pixels of the current block of the intra prediction to be performed by the intra prediction section 134 of the enhancement layer image encoding section 105. The availability determination section 154 determines the availability of the peripheral pixels. The availability determination section 154 supplies the result of the determination (availability) to the filling pixel generation section 155.

The filling pixel generation section 155 determines whether or not there is an unavailable peripheral pixel based on the result of the determination supplied from the availability determination section 154, and when there is one, generates a filling pixel with which the unavailable peripheral pixel is filled.

At this time, when the value of the base layer pixel filling control information (fill_with_baselayer_pixel_flag) supplied from the base layer pixel filling control information setting section 172 is “1,” the filling pixel generation section 155 generates a filling pixel using a pixel of the base layer. In other words, the filling pixel generation section 155 reads the up-sampled image from the base layer pixel memory 152, and generates a filling pixel using the pixel value of a pixel of the base layer corresponding to the unavailable peripheral pixel.

In addition, when the value of the base layer pixel filling control information (fill_with_baselayer_pixel_flag) supplied from the base layer pixel filling control information setting section 172 is “0,” the filling pixel generation section 155 generates a filling pixel using a pixel of the enhancement layer. In other words, the filling pixel generation section 155 acquires an enhancement layer reference image from the frame memory 122 of the enhancement layer image encoding section 105, and generates a filling pixel using the pixel value of an unavailable pixel included in the enhancement layer reference image.

The filling pixel generation section 155 supplies the filling pixel generated as above to the intra prediction section 134 of the enhancement layer image encoding section 105. The intra prediction section 134 performs intra prediction using the supplied filling pixel, and thereby generates a predictive image.

As described above, the scalable encoding device 100 can fill an unavailable peripheral pixel with a pixel of the base layer in intra prediction in encoding of the enhancement layer, and thus deterioration of prediction accuracy and a decrease in encoding efficiency can also be suppressed in constrained intra. Thereby, the scalable encoding device 100 can suppress deterioration in image quality resulting from encoding and decoding.

<Flow of the Encoding Process>

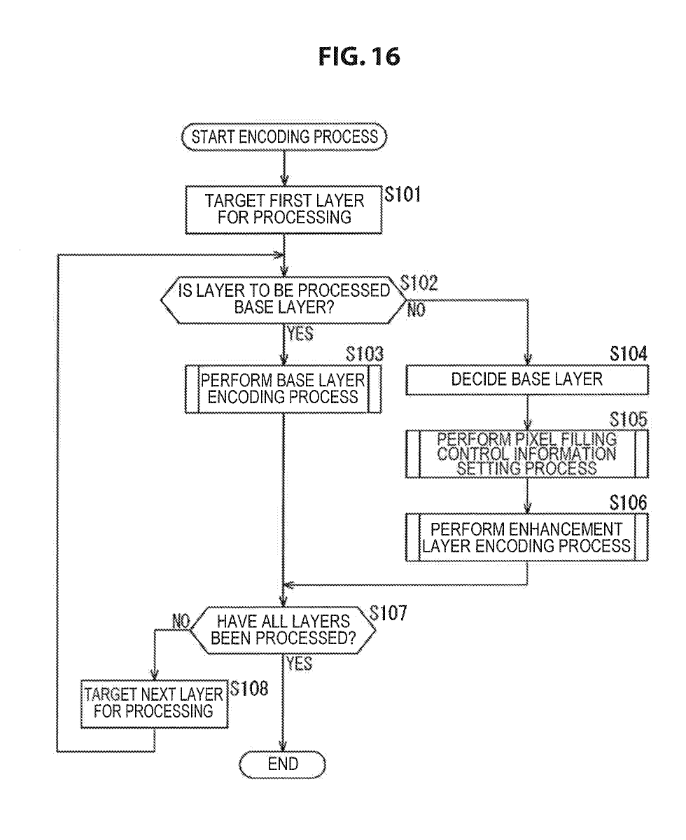

Next, the flow of each process executed by the scalable encoding device 100 as described above will be described. First, an example of the flow of the encoding process will he described with reference to the flow chart of FIG. 16. The scalable encoding device 100 executes this encoding process for each picture.

When the encoding process starts, the encoding control section 102 of the scalable encoding device 100 targets a first layer for processing in Step S101.

In Step S102, the encoding control section 102 determines whether or not the current layer that is the processing target is the base layer. When the current layer is determined to be the base layer, the process proceeds to Step S103.

In Step S103, the base layer image encoding section 103 performs a base layer encoding process. When the process of Step S103 ends, the process proceeds to Step S107.

In addition, when the current layer is determined to be an enhancement layer in Step S102, the process proceeds to Step S104. In Step S104, the encoding control section 102 decides a base layer corresponding to the current layer (in other words, as a reference destination).

In Step S105, the pixel filling section 104 performs a pixel filling control information setting process.

In Step S106, the enhancement layer image encoding section 105 performs an enhancement layer encoding process. When the process of Step S106 ends, the process proceeds to Step S107.

In step S107, the encoding control section 102 determines whether or not all the layers have been processed. When it is determined that there is a non-processed layer, the process proceeds to step S108.

In step S108, the encoding control section 102 sets a next non-processed layer as a processing target (current layer). When the process of step S108 ends, the process returns to step S102. The process of steps S102 to S108 is repeatedly performed to encode the layers.

Then, when all the layers are determined to have been processed in step S107, the encoding process ends.

<Flow of Base Layer Encoding Process>

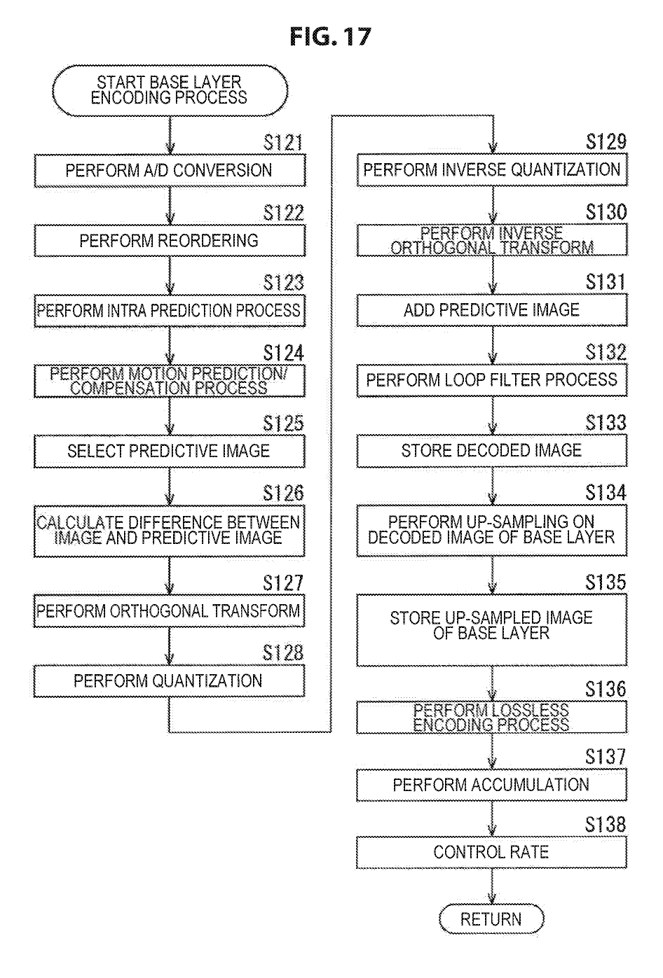

Next, an example of the flow of the base layer encoding process executed in step S103 of FIG. 16 will be described with reference to a flowchart of FIG. 17.

In step S121, the A/D converting section 111 of the base layer image encoding section 103 performs A/D conversion on input image information (image data) of the base layer. In step S122, the screen reordering buffer 112 stores image information (digital data) of the base layer that has been subjected to the A/D conversion, and reorders the pictures arranged in the display order in the encoding order.

In step S123, the intra prediction section 124 performs the intra prediction process in the intra prediction mode. In step S124, the motion prediction/compensation section 125 performs a motion prediction/compensation process in which motion prediction and motion compensation in the inter prediction mode are performed. In step S125, the predictive image selecting section 126 decides an optimal mode based on the cost function values output from the intra prediction section 124 and the motion prediction/compensation section 125. In other words, the predictive image selecting section 126 selects either of the predictive image generated by the intra prediction section 124 and the predictive image generated by the motion prediction/compensation section 125. In step S126, the operation section 113 calculates a difference between the image reordered in the process of step S122 and the predictive image selected in the process of step S125. The differential data is smaller in a data amount than the original image data. Thus, it is possible to compress a data amount to be smaller than when an image is encoded without change.

In step S127, the orthogonal transform section 114 performs the orthogonal transform process on the differential information generated in the process of step S126. In step S128, the quantization section 115 quantizes the orthogonal transform coefficients obtained in the process of step S127 using the quantization parameter calculated by the rate control section 127.

The differential information quantized in the process of step S128 is locally decoded as follows. In other words, in step S129, the inverse quantization section 118 performs inverse quantization on the quantized coefficients (which are also referred to as “quantization coefficients”) quantized in the process of step S128 according to characteristics corresponding to characteristics of the quantization section 115. In step S130, the inverse orthogonal transform section 119 performs the inverse orthogonal transform on the orthogonal transform coefficients obtained in the process of step S127. In step S131, the operation section 120 generates a locally decoded image (an image corresponding to an input of the operation section 113) by adding the predictive image to the locally decoded differential information.

In step S132, the loop filter 121 performs filtering on the image generated in the process of step S131. As a result, for example, block distortion is removed. In step S133, the frame memory 122 stores the image in which, for example, the block distortion has been deleted in the process of step S132. The image that is not subjected to the filter process performed by the loop filter 121 is also supplied from the operation section 120 and stored in the frame memory 122. The image stored in the frame memory 122 is used in the process of step S123 or the process of step S124.

In Step S134, the up-sampling section 151 of the pixel filling section 104 performs up-sampling on the decoded image of the base layer.

In Step S135, the base layer pixel memory 152 of the pixel filling section 104 stores the up-sampled image obtained from the process of Step S134.

In step S136, the lossless encoding section 116 of the base layer image encoding section 103 encodes the coefficients quantized in the process of step S128. In other words, lossless coding such as variable length coding or arithmetic coding is performed on data corresponding to the differential image.

At this time, the lossless encoding section 116 encodes information related to the prediction mode of the predictive image selected in the process of step S125, and adds the encoded information to the encoded data obtained by encoding the differential image. In other words, the lossless encoding section 116 also encodes, for example, information according to the optimal intra prediction mode information supplied from the intra prediction section 124 or the optimal inter prediction mode supplied from the motion prediction/compensation section 125, and adds the encoded information to the encoded data.

In step S137, the accumulation buffer 117 accumulates the base layer encoded data obtained in the process of step S136. The base layer encoded data accumulated in the accumulation buffer 117 is appropriately read and transmitted to the decoding side via a transmission path or a recording medium.

In step S138, the rate control section 127 controls the quantization operation of the quantization section 115 based on the coding amount (the generated coding amount) of the encoded data accumulated in the accumulation buffer 117 in step S137 so that no overflow or underflow occurs.

When the process of Step S138 ends, the base layer encoding process ends, and the process returns to the process of FIG. 16. The base layer encoding process is executed in units of, for example, pictures. In other words, the base layer encoding process is executed on each picture of a current layer. However, each process included in the enhancement layer encoding process is performed in the processing unit thereof.

<Flow of the Pixel Filling Control Information Setting Process>

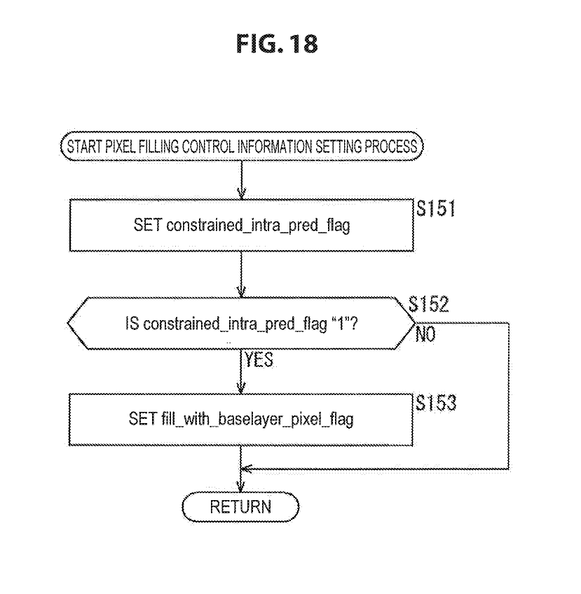

Next, an example of the flow of the pixel filling control information setting process executed in Step S105 of FIG. 16 will be described with reference to FIG. 18.

When the pixel filling control information setting process starts, the Constrained_ipred setting section 171 of the pixel filling control information setting section 153 of the pixel filling section 104 sets constrained intra control information (constrained_intra_pred_flag) in Step S151.

In Step S152, the base layer pixel filling control information setting section 172 determines whether or not the value of the constrained intra control information (constrained_intra_pred_flag) set in Step S151 is “1.” When the value is determined to be “1,” the process proceeds to Step S153.

In Step S153, the base layer pixel filling control information setting section 172 sets base layer pixel filling control information (fill_with_baselayer_pixel_flag). When the process of Step S153 ends, the pixel filling control information setting process ends, and the process returns to the process of FIG. 16.

In addition, in Step S152, when the value of the constrained intra control information (constrained_intra_pred_flag) is determined to be “0,” the process of Step S153 is skipped, the pixel filling control information setting process ends, and then the process returns to the process of FIG. 16.

<Flow of the Enhancement Layer Encoding Process>

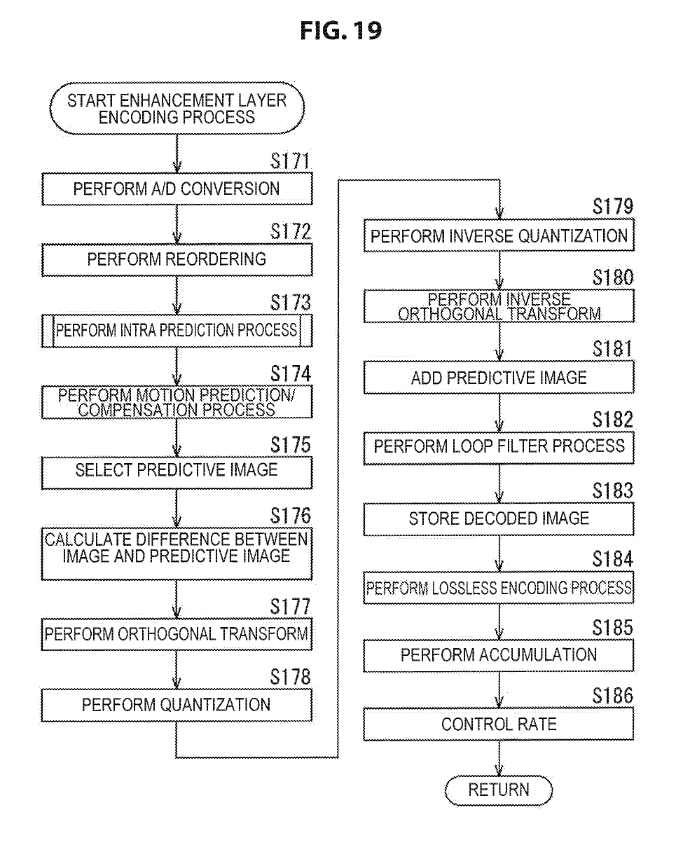

Next, an example of the flow of the enhancement layer encoding process performed in Step S106 of FIG. 16 will he described with reference to the flow chart of FIG. 19.

The processes of Steps S171 and S172 and Steps S174 to S186 of the enhancement layer encoding process are executed in the same manner as the processes of Steps S121 and S122, Steps S124 to S133, and Steps S136 to S138 of the base layer encoding process of FIG. 17. However, the processes of the enhancement layer encoding process are performed on enhancement layer image information by each processing section of the enhancement layer image encoding section 105.

Note that, in Step S173, the intra prediction section 134 and the pixel filling section 104 of the enhancement layer image encoding section 105 perform an intra prediction process on the enhancement layer image information. Details of this intra prediction process will be described later.

When the process of Step S186 ends, the enhancement layer encoding process ends, and the process returns to the process of FIG. 16. The enhancement layer encoding process is executed in, for example, units of pictures. In other words, the enhancement layer encoding process is executed for each picture of a current layer. However, each process included in the enhancement layer encoding process is performed in the processing unit thereof.

<Flow of the Intra Prediction Process>

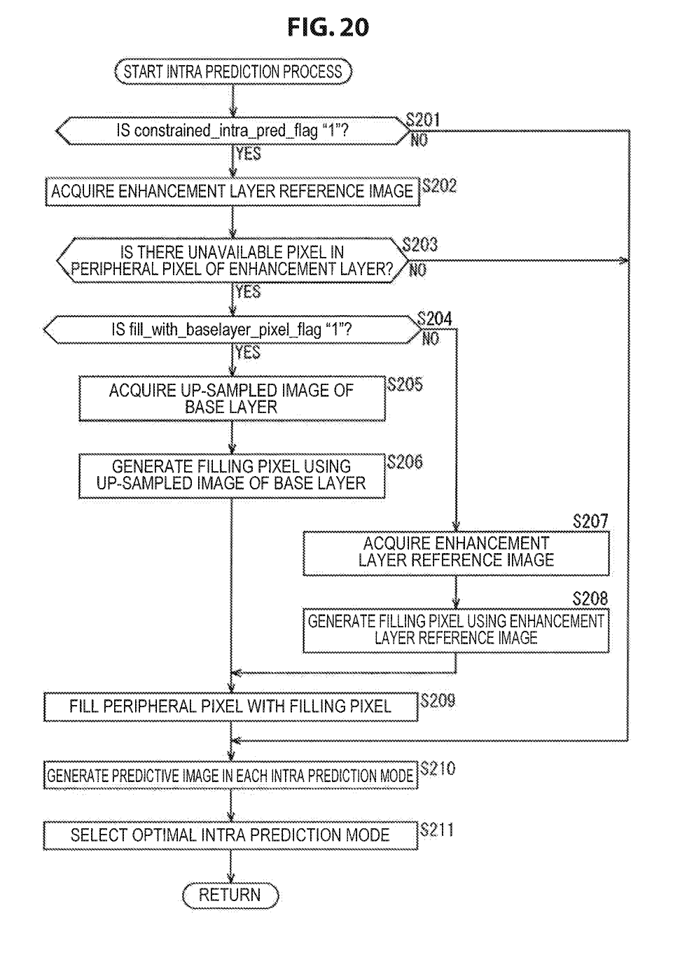

Next, an example of the flow of the intra prediction process executed in Step S173 of FIG. 19 will be described with reference to the flow chart of FIG. 20.

When the intra prediction process starts, the availability determination section 154 determines whether or not the value of the constrained intra control information (constrained_intra_pred_flag) is “1” in Step S201. When the value is determined to be “1,” the process proceeds to Step S202.

In Step S202, the availability determination section 154 acquires an enhancement layer reference image.

In Step S203, the availability determination section 154 determines the availability of peripheral pixels included in the enhancement layer reference image acquired in Step S202. In other words, the availability determination section 154 determines whether or not there is an unavailable pixel in the peripheral pixels of the enhancement layer. When it is determined that there is an unavailable pixel, the process proceeds to Step S204.

In Step S204, the filling pixel generation section 155 determines whether or not the value of the base layer pixel filling control information (fill_with_baselayer_pixel_flag) is “1.” When the value is determined to be “1,” the process proceeds to Step S205.

In Step S205, the filling pixel generation section 155 acquires an up-sampled image of the base layer stored in the base layer pixel memory 152.

In Step S206, the filling pixel generation section 155 generates a filling pixel using the up-sampled image of the base layer acquired from the process of Step S205. When the process of Step S206 ends, the process proceeds to Step S209.

In addition, when the value of the base layer pixel filling control information (fill_with_baselayer_pixel_flag) is determined to be “0” in Step S204, the process proceeds to Step S207.

In Step S207, the filling pixel generation section 155 acquires the enhancement layer reference image stored in the frame memory 122 of the enhancement layer image encoding section 105.

In Step S208, the filling pixel generation section 155 generates a filling pixel using the enhancement layer reference image acquired from the process of Step S207. When the process of Step S208 ends, the process proceeds to Step S209.

In Step S209, the filling pixel generation section 155 supplies the filling pixel generated in Step S206 or Step S208 to the intra prediction section 134 of the enhancement layer image encoding section 105 to fill the unavailable peripheral pixel of the enhancement layer with the filling pixel.

In Step S210, the intra prediction section 134 of the enhancement layer image encoding section 105 generates predictive images in the respective intra prediction modes.

In Step S211, the intra prediction section 134 of the enhancement layer image encoding section 105 computes the cost function values of the predictive images of the respective intra prediction modes generated in Step S210, and based on the values, selects an intra prediction mode that is optimal (which will also be referred to as an optimal intra prediction mode).

When the process of Step S211 ends, the intra prediction process ends, and the process returns to the process of FIG. 19.

By executing the processes as described above, the scalable encoding device 100 can suppress a decrease in encoding efficiency and deterioration in image quality resulting from encoding and decoding.

### 2. Second Embodiment

<Scalable Decoding Device>

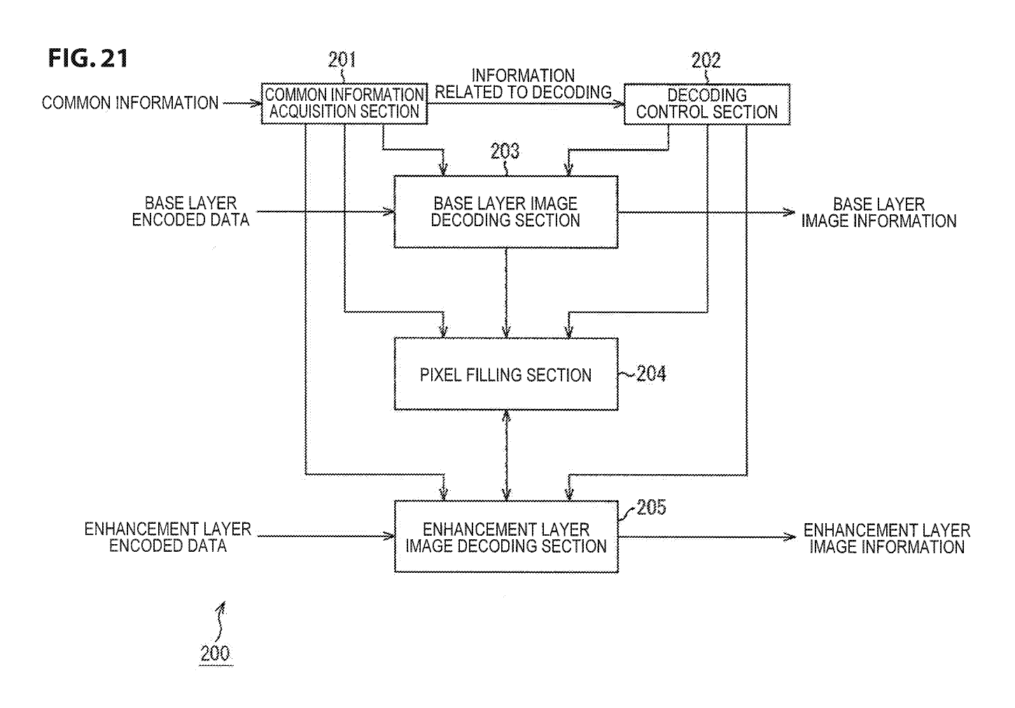

Next, decoding of the encoded data (bitstream) that has been subjected to the scalable video coding as described above will be described. FIG. 21 is a block diagram illustrating an example of a main configuration of a scalable decoding device corresponding to the scalable encoding device 100 of FIG. 12. For example, a scalable decoding device 200 illustrated in FIG. 21 performs scalable decoding on the encoded data obtained by performing the scalable encoding on the image data through the scalable encoding device 100 according to a method corresponding to the encoding method.

As illustrated in FIG. 21, the scalable decoding device 200 has a common information acquisition section 201, a decoding control section 202, a base layer image decoding section 203, a pixel filling section 204, and an enhancement layer image decoding section 205.

The common information acquisition section 201 acquires common information transmitted from the encoding side (for example, a video parameter set (VPS)). The common information acquisition section 201 extracts information related to decoding from the acquired common information and supplies the information to the decoding control section 202. In addition, the common information acquisition section 201 appropriately supplies part or all of the common information to the base layer image decoding section 203 to the enhancement layer image decoding section 205.

The decoding control section 202 acquires the information related to decoding supplied from the common information acquisition section 201, and controls decoding of each layer by controlling the base layer image decoding section 203 to the enhancement layer image decoding section 205 based on the information.

The base layer image decoding section 203 is an image decoding section which corresponds to the base layer image encoding section 103, and acquires base layer encoded data obtained by, for example, the base layer image encoding section 103 encoding base layer image information. The base layer image decoding section 203 decodes the base layer encoded data to reconstruct the base layer image information without using information of another layer and outputs the data. In addition, the base layer image decoding section 203 supplies a baser layer decoded image obtained in the decoding to the pixel filling section 204.

The pixel filling section 204 performs a process related to filling of the peripheral pixel when constrained intra is used in intra prediction by the enhancement layer image decoding section 205. For example, the pixel filling section 204 acquires the decoded image of the base layer from the base layer image decoding section 203, and fills the unavailable peripheral pixel of the enhancement layer with a pixel of the base layer. The pixel filling section 204 supplies the filling pixel for the peripheral pixel to the enhancement layer image decoding section 205.

The enhancement layer image decoding section 205 is an image decoding section corresponding to the enhancement layer image encoding section 105, and acquires, for example, the enhancement layer encoded data obtained by encoding the enhancement layer image information through the enhancement layer image encoding section 105. The enhancement layer image decoding section 205 decodes the enhancement layer encoded data. In the decoding, the enhancement layer image decoding section 205 supplies the peripheral pixel of the enhancement layer to the pixel filling section 204 when generating a predictive image of a current block by performing intra prediction. In addition, the enhancement layer image decoding section 205 acquires the tilling pixel for the peripheral pixel of the current block from the pixel filling section 204. The enhancement layer image decoding section 205 performs intra prediction using the filling pixel, then generates the predictive image, re-constructs the enhancement layer image information using the predictive image, and then outputs the information.

<Base Layer Image Decoding Section>

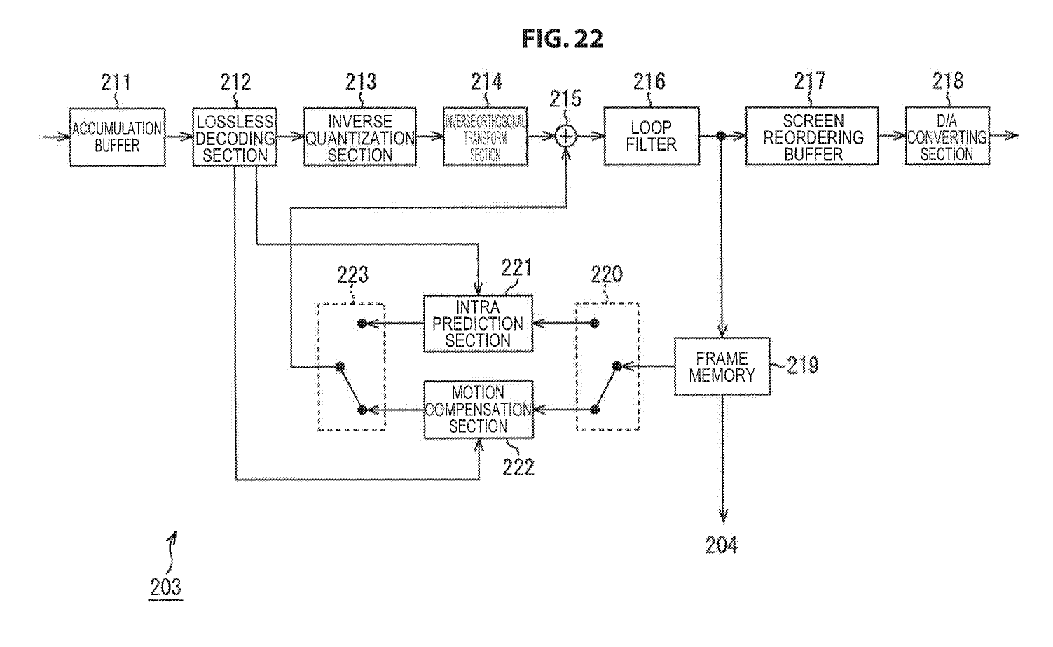

FIG. 22 is a block diagram illustrating an example of a main configuration of the base layer image decoding section 203 of FIG. 21. As illustrated in FIG. 22, the base layer image decoding section 203 includes an accumulation buffer 211, a lossless decoding section 212, an inverse quantization section 213, an inverse orthogonal transform section 214, an operation section 215, a loop filter 216, a screen reordering buffer 217, and a D/A converting section 218. The base layer image decoding section 203 further includes a frame memory 219, a selecting section 220, an intra prediction section 221, a motion compensation section 222, and a selecting section 223.

The accumulation buffer 211 is a receiving section that receives the transmitted base layer encoded data. The accumulation buffer 211 receives and accumulates the transmitted base layer encoded data, and supplies the encoded data to the lossless decoding section 212 at a certain timing. Information necessary for decoding of the prediction mode information or the like is added to the base layer encoded data.

The lossless decoding section 212 decodes the information that has been encoded by the lossless encoding section 116 and supplied from the accumulation buffer 211 according to a scheme corresponding to the encoding scheme of the lossless encoding section 116. The lossless decoding section 212 supplies quantized coefficient data of a differential image obtained by the decoding to the inverse quantization section 213.

Further, the lossless decoding section 212 appropriately extracts and acquires the NAL unit including the video parameter set (VPS), the sequence parameter set (SPS), the picture parameter set (PPS), and the like which are included in the base layer encoded data. The lossless decoding section 212 extracts the information related to the optimal prediction mode from the information, determines which of the intra prediction mode and the inter prediction mode has been selected as the optimal prediction mode based on the information, and supplies the information related to the optimal prediction mode to one of the intra prediction section 221 and the motion compensation section 222 that corresponds to the mode determined to have been selected, in other words, for example, in the base layer image encoding section 103, when the intra prediction mode is selected as the optimal prediction mode, the information related to the optimal prediction mode is supplied to the intra prediction section 221. Further, for example, in the base layer image encoding section 103, when the inter prediction mode is selected as the optimal prediction mode, the information related to the optimal prediction mode is supplied to the motion compensation section 222.

Further, the lossless decoding section 212 extracts information necessary for inverse quantization such as the quantization matrix or the quantization parameter from the NAL unit, and supplies the extracted information to the inverse quantization section 213.

The inverse quantization section 213 inversely quantizes the quantized coefficient data obtained through the decoding performed by the lossless decoding section 212 according to a scheme corresponding to the quantization scheme of the quantization section 115. The inverse quantization section 213 is the same processing section as the inverse quantization section 118. In other words, the description of the inverse quantization section 213 can be applied to the inverse quantization section 118 as well. Here, it is necessary to appropriately change and read a data input/output destination or the like according to a device. The inverse quantization section 213 supplies the obtained coefficient data to the inverse orthogonal transform section 214.

The inverse orthogonal transform section 214 performs the inverse orthogonal transform on the coefficient data supplied from the inverse quantization section 213 according to a scheme corresponding to the orthogonal transform scheme of the orthogonal transform section 114. The inverse orthogonal transform section 214 is the same processing section as the inverse orthogonal transform section 119. In other words, the description of the inverse orthogonal transform section 214 can be applied to the inverse orthogonal transform section 119 as well. Here, it is necessary to appropriately change and read a data input/output destination or the like according to a device

The inverse orthogonal transform section 214 obtains decoded residual data corresponding to residual data that is not subjected to the orthogonal transform in the orthogonal transform section 114 through the inverse orthogonal transform process. The decoded residual data obtained through the inverse orthogonal transform is supplied to the operation section 215. Further, the predictive image is supplied from the intra prediction section 221 or the motion compensation section 222 to the operation section 215 via the selecting section 223.

The operation section 215 adds the decoded residual data and the predictive image, and obtains decoded image data corresponding to the image data from which the predictive image is not subtracted by the operation section 113. The operation section 215 supplies the decoded image data to the loop filter 216.

The loop filter 216 appropriately performs the filter process such as the deblock filter or the adaptive loop filter on the supplied decoded image, and supplies the resultant image to the screen reordering buffer 217 and the frame memory 219. For example, the loop filter 216 removes the Nock distortion of the decoded image by performing the deblock filter process on the decoded image. Further, for example, the loop filter 216 improves the image quality by performing the loop filter process on the deblock filter process result (the decoded image from which the block distortion has been removed) using the Wiener filter. The loop filter 216 is the same processing section as the loop filter 121.

Further, the decoded image output from the operation section 215 can be supplied to the screen reordering buffer 217 or the frame memory 219 without intervention of the loop filter 216. In other words, part or all of the filter process performed by the loop filter 216 can be omitted.

The screen reordering buffer 217 reorders the decoded image. In other words, the order of the frames reordered in the encoding order by the screen reordering buffer 112 is reordered in the original display order. The D/A converting section 218 performs D/A conversion on the image supplied from the screen reordering buffer 217, and outputs the converted image to be displayed on a display (not illustrated).

The frame memory 219 stores the supplied decoded image, and supplies the stored decoded image to the selecting section 220 as the reference image at a certain timing or based on an external request, for example, from the intra prediction section 221, the motion compensation section 222, or the like.

The selecting section 220 selects the supply destination of the reference image supplied from the frame memory 219. When an image encoded by the intra coding is decoded, the selecting section 220 supplies the reference image supplied from the frame memory 219 to the intra prediction section 221. Further, when an image encoded by the inter coding is decoded, the selecting section 220 supplies the reference image supplied from the frame memory 219 to the motion compensation section 222.

For example, the information indicating the intra prediction mode obtained by decoding the header information is appropriately supplied from the lossless decoding section 212 to the intra prediction section 221. The intra prediction section 221 generates the predictive image by performing the intra prediction using the reference image acquired from the frame memory 219 in the intra prediction mode used in the intra prediction section 124. The intra prediction section 221 supplies the generated predictive image to the selecting section 223.

The motion compensation section 222 acquires information (optimal prediction mode information, reference image information, and the like) obtained by decoding the header information from the lossless decoding section 212.

The motion compensation section 222 generates the predictive image by performing the motion compensation using the reference image acquired from the frame memory 219 in the inter prediction mode indicated by the optimal prediction mode information acquired from the lossless decoding section 212. The motion compensation section 222 supplies the generated predictive image to the selecting section 223.

The selecting section 223 supplies the predictive image supplied from the intra prediction section 221 or the predictive image supplied from the motion compensation section 222 to the operation section 215. Then, the operation section 215 adds the predictive image generated using the motion vector to the decoded residual data (the differential image information) supplied from the inverse orthogonal transform section 214 to decode the original image.

Note that the frame memory 219 supplies the stored base layer decoded image to the pixel filling section 204.

<Enhancement Layer Image Encoding Section>

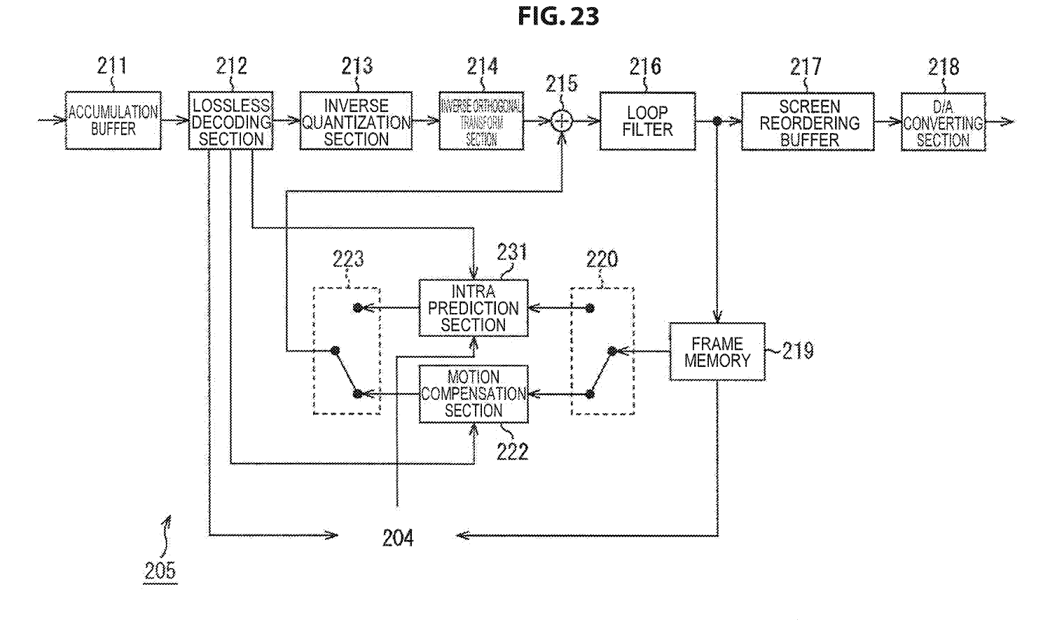

FIG. 23 is a block diagram illustrating a main configuration example of the enhancement layer image decoding section 205 of FIG. 21. As illustrated in FIG. 23, the enhancement layer image decoding section 205 basically has the same configuration as the base layer image decoding section 203 of FIG. 22.

However, respective sections of the enhancement layer image decoding section 205 perform processes for decoding enhancement layer encoded data rather than the base layer. In other words, the accumulation buffer 211 of the enhancement layer image decoding section 205 stores the enhancement layer encoded data, and the D/A converting section 218 of the enhancement layer image decoding section 205 outputs enhancement layer image information to, for example, a recording device (recording medium) provided in the later stage but not illustrated, a transmission path, or the like.

In addition, the enhancement layer image decoding section 205 has an intra prediction section 231 instead of the intra prediction section 221.

The intra prediction section 231 acquires the filling pixel generated by the pixel filling section 204, performs intra prediction of the enhancement layer using the peripheral pixel of the current block filled with the filling pixel, and thereby generates a predictive image. The intra prediction is performed in the same manner as by the intra prediction section 221.

Note that the frame memory 219 supplies the stored decoded image (enhancement layer decoded image) to the pixel filling section 204. In addition, the lossless decoding section 212 supplies the constrained intra control information (constrained_intra_pred_flag) and the base layer pixel filling control information (fill_with_baselayer_pixel_flag) transmitted from the encoding side to the pixel filling section 204. For example, the lossless decoding section 212 extracts encoded data of the constrained intra control information (constrained_intra_pred_flag) and the base layer pixel filling control information (fill^{—}with_baselayer_pixel _flag) from the picture parameter set (PPS) transmitted from the encoding side, and supplies the data to the pixel filling section 204.

<Pixel Filling Section>

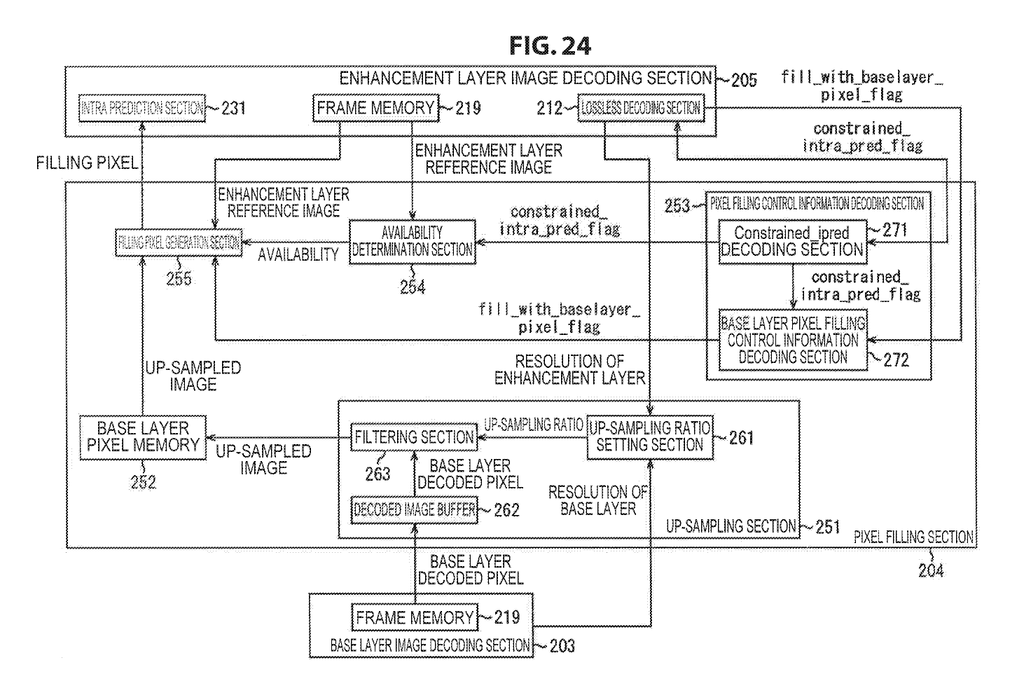

FIG. 24 is a block diagram illustrating a main configuration example of the pixel filling section 204 of FIG. 21.

As illustrated in FIG. 24, the pixel filling section 204 has an up-sampling section 251, a base layer pixel memory 252, a pixel filling control information decoding section 253, an availability determination section 254, and a filling pixel generation section 255.

The up-sampling section 251 performs an up-sampling process (conversion process) of the base layer decoded image. As illustrated in FIG. 24, the up-sampling section 251 has an up-sampling ratio setting section 261, a decoded image buffer 262, and a filtering section 263.

The up-sampling ratio setting section 261 sets an up-sampling ratio of the up-sampling process of the base layer decoded image. The up-sampling ratio setting section 261 acquires the resolution of the enhancement layer from, for example, the lossless decoding section 212 of the enhancement layer image decoding section 205. In addition, the up-sampling ratio setting section 261 acquires the resolution of the base layer from the base layer image decoding section 203 (for example, the lossless decoding section 212, or the like). The up-sampling ratio setting section 261 sets an up-sampling ratio based on the information. In other words, the up-sampling ratio setting section 261 can set the up-sampling ratio according to the resolution ratio between the base layer and the enhancement layer. Accordingly, the up-sampling section 251 can perform the up-sampling process on the base layer decoded image at the ratio according to the resolution ratio of the base layer and the enhancement layer. The up-sampling ratio setting section 261 supplies the set up-sampling ratio to the filtering section 263.

The decoded image buffer 262 stores the base layer decoded image supplied from the frame memory 219 of the base layer image decoding section 203. The decoded image buffer 262 supplies the stored base layer decoded image to the filtering section 263.

The filtering section 263 performs the up-sampling process on the base layer decoded image read from the decoded image buffer 262 at the up-sampling ratio supplied from the up-sampling ratio setting section 261. The filtering section 263 supplies the obtained up-sampled image to the base layer pixel memory 252.

The base layer pixel memory 252 stores the up-sampled image supplied from the filtering section 263. The base layer pixel memory 252 supplies the stored up-sampled image to the filling pixel generation section 255.

The pixel filling control information decoding section 253 acquires and decodes the encoded data of the control information related to pixel filling transmitted from the encoding side supplied from the lossless decoding section 212 of the enhancement layer image decoding section 205. As illustrated in FIG. 24, the pixel filling control information decoding section 253 has a Constrained_ipred decoding section 271 and a base layer pixel filling control information decoding section 272.

The Constrained_ipred decoding section 271 acquires and decodes the encoded data of the constrained intra control information (constrained_intra_pred_flag) supplied from the lossless decoding section 212 of the enhancement layer image decoding section 205.

The Constrained_ipred decoding section 271 supplies the obtained constrained intra control information (constrained_intra_pred_flag) to the base layer pixel filling control information decoding section 272. In addition, the Constrained_ipred decoding section 271 also supplies the obtained constrained intra control information (constrained_intra_pred_flag) to the availability determination section 254.

When the value of the constrained intra control information (constrained_intra_pred_flag) supplied from the Constrained_ipred decoding section 271 is “1,” the base layer pixel filling control information decoding section 272 acquires and decodes the encoded data of the base layer pixel filling control information (fill_with_baselayer_pixel_flag) supplied from the lossless decoding section 212 of the enhancement layer image decoding section 205. The base layer pixel filling control information decoding section 272 supplies the obtained base layer pixel filling control information (fill_with_baselayer_pixel_flag) to the filling pixel generation section 255.

When the value of the constrained intra control information (constrained_intra_pred_flag) supplied from the Constrained_ipred decoding section 271 is “1,” the availability determination section 254 acquires the enhancement layer reference image from the frame memory 219 of the enhancement layer image decoding section 205. The enhancement layer reference image includes the peripheral pixel of the current block for intra prediction to be performed by the intra prediction section 231 of the enhancement layer image decoding section 205. The availability determination section 254 determines the availability of the peripheral pixel. The availability determination section 254 supplies the result of the determination (availability) to the filling pixel generation section 255.

The filling pixel generation section 255 determines whether or not there is an unavailable peripheral pixel based on the result of the determination supplied from the availability determination section 254, and when it is determined that there is one, generates a filling pixel which fills the unavailable peripheral pixel.

At this time, when the value of the base layer pixel filling control information (fill_with_baselayer_pixel_flag) supplied from the base layer pixel filling control information decoding section 272 is “1,” the filling pixel generation section 255 generates the filling pixel using a pixel of the base layer. In other words, the filling pixel generation section 255 reads the up-sampled image from the base layer pixel memory 252, and then generates the filling pixel using the pixel value of the pixel of the base layer which corresponds to the unavailable peripheral pixel.

In addition, when the value of the base layer pixel filling control information (fill_with_baselayer_pixel_flag) supplied from the base layer pixel filling control information decoding section 272 is “0,” the filling pixel generation section 255 generates the filling pixel using a pixel of the enhancement layer. In other words, the filling pixel generation section 255 acquires the enhancement layer reference image from the frame memory 219 of the enhancement layer image decoding section 205, and then generates the filling pixel using the pixel value of the unavailable pixel included in the enhancement layer reference image.

The filling pixel generation section 255 supplies the filling pixel generated as above to the intra prediction section 231 of the enhancement layer image decoding section 205. The intra prediction section 231 performs intra prediction using the supplied filling pixel and thereby generates a predictive image.

As described above, the scalable decoding device 200 can fill the unavailable peripheral pixel with a pixel of the base layer in intra prediction of decoding of the enhancement layer, and thus deterioration in prediction accuracy and a decrease in encoding efficiency can be suppressed in the case of constrained intra. Thereby, the scalable decoding device 200 can suppress deterioration in image quality resulting from encoding and decoding.

<Flow of the Decoding Process>

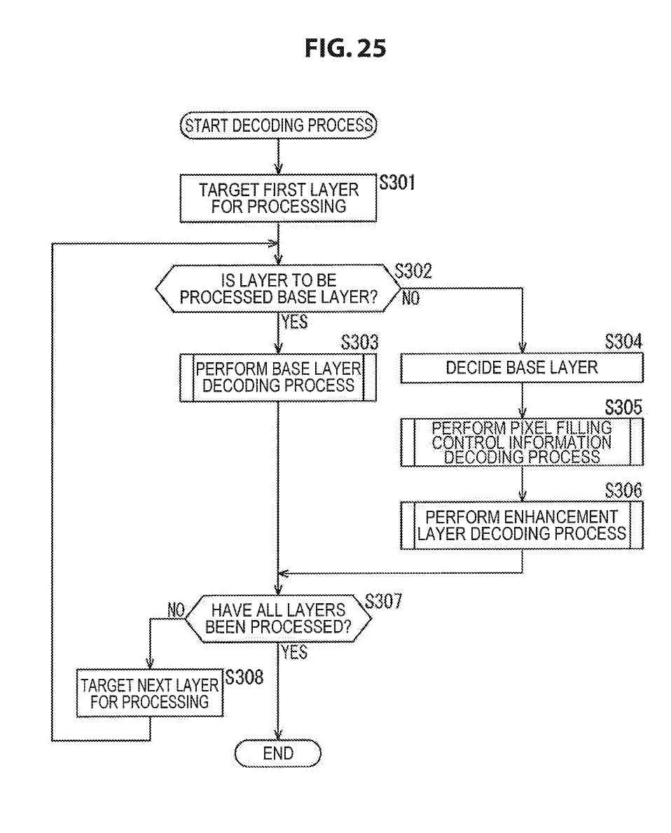

Next, the flow of each process executed by the scalable decoding device 200 as above will be described. First, an example of the flow of the decoding process will be described with reference to the flow chart of FIG. 25. The scalable decoding device 200 executes this decoding process for each picture.

When the decoding process starts, the decoding control section 202 of the scalable decoding device 200 targets a first layer for processing in Step S301.

In Step S302, the decoding control section 202 determines whether or not a current layer to he processed is a base layer. When the current layer is determined to be the base layer, the process proceeds to Step S303.

In Step S303, the base layer image decoding section 203 performs a base layer decoding process. When the process of Step S303 ends, the process proceeds to Step S307.

In addition, when the current layer is determined to be the enhancement layer in Step S302, the process proceeds to Step S304. In Step S304, the decoding control section 202 decides the base layer corresponding to the current layer (in other words, to be a reference destination).

In Step S305, the pixel filling section 204 performs a pixel filling control information setting process.

In Step S306, the enhancement layer image decoding section 205 performs an enhancement layer decoding process. When the process of Step S306 ends, the process proceeds to Step S307.

In step S307, the decoding control section 202 determines whether or not all the layers have been processed. When it is determined that there is a non-processed layer, the process proceeds to step S308.

In step S308, the decoding control section 202 sets a next non-processed layer as a processing target (current layer). When the process of step S308 ends, the process returns to step S302. The process of steps S302 to S308 is repeatedly performed to decode the layers.

Then, when all the layers are determined to have been processed in step S307, the decoding process ends.

<Flow of Base Layer Decoding Process>

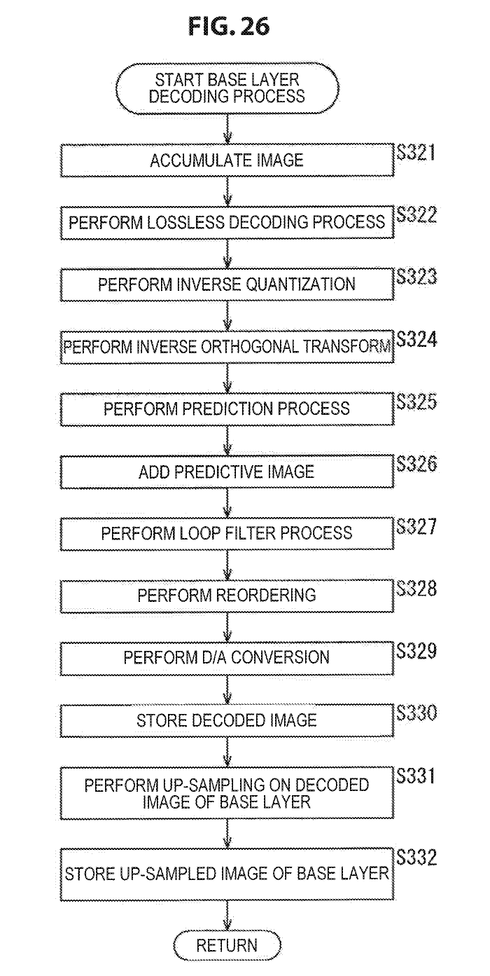

Next, an example of the flow of the base layer decoding process performed in step S303 of FIG. 25 will be described with reference to a flowchart of FIG. 26.

When the base layer decoding process starts, in step S321, the accumulation buffer 211 of the base layer image decoding section 203 accumulates the bitstreams of the base layer transmitted from the encoding side. In step S322, the lossless decoding section 212 decodes the bitstream (the encoded differential image information) of the base layer supplied from the accumulation buffer 211. In other words, the I picture, the P picture, and the B picture encoded by the lossless encoding section 116 are decoded. At this time, various kinds of information other than the differential image information included in the bitstream, such as the header information, are also decoded.

In step S323, the inverse quantization section 213 inversely quantizes the quantized coefficients obtained in the process of step S322.

In step S324, the inverse orthogonal transform section 214 performs the inverse orthogonal transform on a current block (a current TU).

In step S325, the intra prediction section 221 or the motion compensation section 222 performs the prediction process, and generates the predictive image. In other words, the prediction process is performed in the prediction mode that is determined to have been applied at the time of encoding in the lossless decoding section 212. More specifically, for example, when the intra prediction is applied at the time of encoding, the intra prediction section 221 generates the predictive image in the intra prediction mode recognized to be optimal at the time of encoding. Further, for example, when the inter prediction is applied at the time of encoding, the motion compensation section 222 generates the predictive image in the inter prediction mode recognized to be optimal at the time of encoding.

In step S326, the operation section 215 adds the predictive image generated in step S325 to the differential image information generated by the inverse orthogonal transform process of step S324. As a result, the original image is decoded.

In step S327, the loop filter 216 appropriately performs the loop filter process on the decoded image obtained in step S326.

In step S328, the screen reordering buffer 217 reorders the image that has been subjected to the filter process in step S327. In other words, the order of the frames reordered for encoding through the screen reordering buffer 112 is reordered in the original display order.

In step S329, the D/A converting section 218 performs D/A conversion on the image in which the order of the frames is reordered in step S328. The image is output to a display (not illustrated), and the image is displayed.

In step S330, the frame memory 219 stores the decoded image that has been subjected to the loop filter process in step S327.

In Step S331, the up-sampling section 251 of the pixel tilling section 204 performs the up-sampling process on the base layer decoded image that has undergone the loop filtering process in Step S327 at the up-sampling ratio between the base layer and the enhancement layer in the space direction.

In Step S332, the base layer pixel memory 252 of the pixel filling section 204 stores the up-sampled image of the base layer obtained in Step S331.

When the process of Step S332 ends, the base layer decoding process ends, and the process returns to the process of FIG. 25. The base layer decoding process is executed in, for example, units of pictures. In other words, the base layer decoding process is executed for each picture of a current layer. However, each process included in the enhancement layer encoding process is performed in the processing unit thereof.

<Flow of the Pixel Filling Control Information Decoding Process>

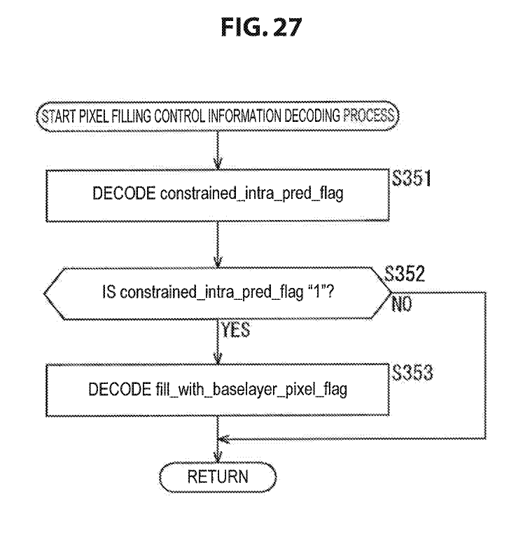

Next, an example of the flow of the pixel filling control information decoding process executed in Step S305 of FIG. 25 will be described with reference to FIG. 27.

When the pixel filling control information decoding process starts, the Constrained_ipred decoding section 271 of the pixel filling control information decoding section 253 of the pixel filling section 204 decodes the constrained intra control information (constrained_intra_pred_flag) transmitted from the encoding side in Step S351.

In Step S352, the base layer pixel filling control information decoding section 272 determines whether or not the value of the constrained intra control information (constrained_intra_pred_flag) obtained in Step S351 is “1.” When the value is determined to be “1,” the process proceeds to Step S353.

In Step S353, the base layer pixel filling control information decoding section 272 decodes the base layer pixel filling control information (fill_with_baselayer_pixel_flag) transmitted from the encoding side. When the process of Step S353 ends, the pixel filling control information decoding process ends, and the process returns to the process of FIG. 25.

In addition, when the value of the constrained intra control information (constrained_intra_pred_flag) transmitted from the encoding side is determined to be “0” in Step S352 of FIG. 27, the process of Step S353 is skipped, the pixel filling control information decoding process ends, and the process returns to the process of FIG. 25.

<Flow of the Enhancement Layer Decoding Process>

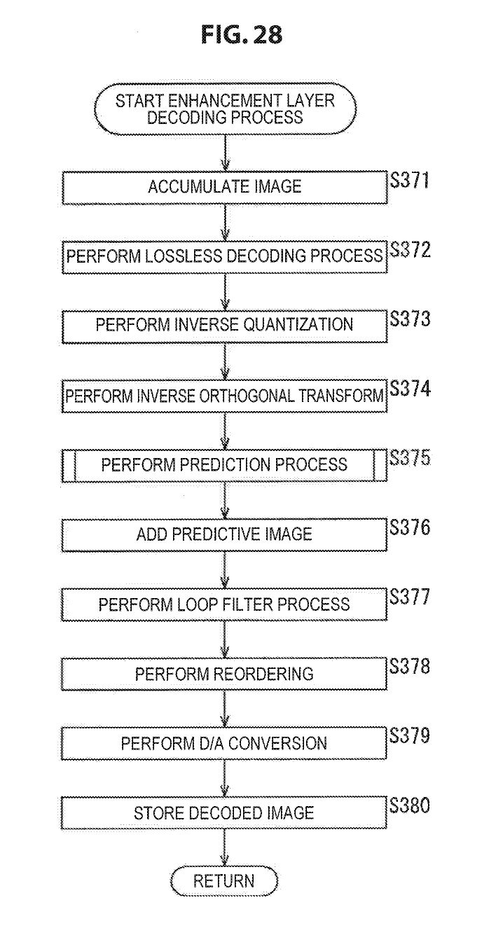

Next, an example of the flow of the enhancement layer decoding process executed in Step S306 of FIG. 25 will be described with reference to the flow chart of FIG. 28.

The respective processes of Steps S371 to S374 and Steps S376 to S380 of the enhancement layer decoding process are executed in the same manner as the respective processes of Steps S321 to S324 and Steps S326 to S330 of the base layer decoding process. The respective processes of the enhancement layer decoding process, however, are performed on enhancement layer encoded data by the respective processing units of the enhancement layer image decoding section 205.

Note that, in Step S375, the intra prediction section 231 and the motion compensation section 222 of the enhancement layer image decoding section 205, and the pixel filling section 204 perform the prediction process on the enhancement layer encoded data.

When the process of Step S380 ends, the enhancement layer decoding process ends, and the process returns to the process of FIG. 25. The enhancement layer decoding process is executed in, for example, units of pictures. In other words, the enhancement layer decoding process is performed on each picture of a current layer. However, each process included in the enhancement layer encoding process is performed in the processing unit thereof.

<Flow of the Prediction Process>

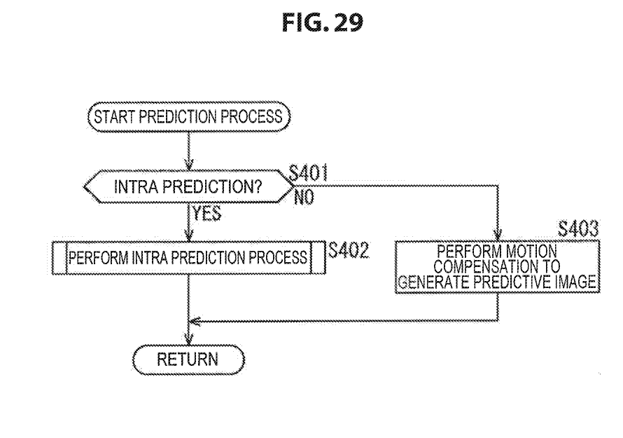

Next, an example of the flow of the prediction process executed in Step S375 of FIG. 28 will be described with reference to the flow chart of FIG. 29.

When the prediction process starts, the intra prediction section 231 of the enhancement layer image decoding section 205 determines whether or not the prediction mode is intra prediction in Step S401. When it is determined to be intra prediction, the process proceeds to Step S402.

In Step S402, the intra prediction section 231 and the pixel filling section 204 perform the intra prediction process. When the intra prediction process ends, the prediction process ends, and the process returns to the process of FIG. 28.

In addition, when it is determined to be inter prediction in Step S401, the process proceeds to Step S403. In Step S403, the motion compensation section 222 performs motion compensation in the optimal inter prediction mode that is the inter prediction mode employed at the time of encoding, and thereby generates a predictive image. When the process of Step S403 ends, the prediction process ends, and the process returns to the process of FIG. 28.

<Flow of the Intra Prediction Process>

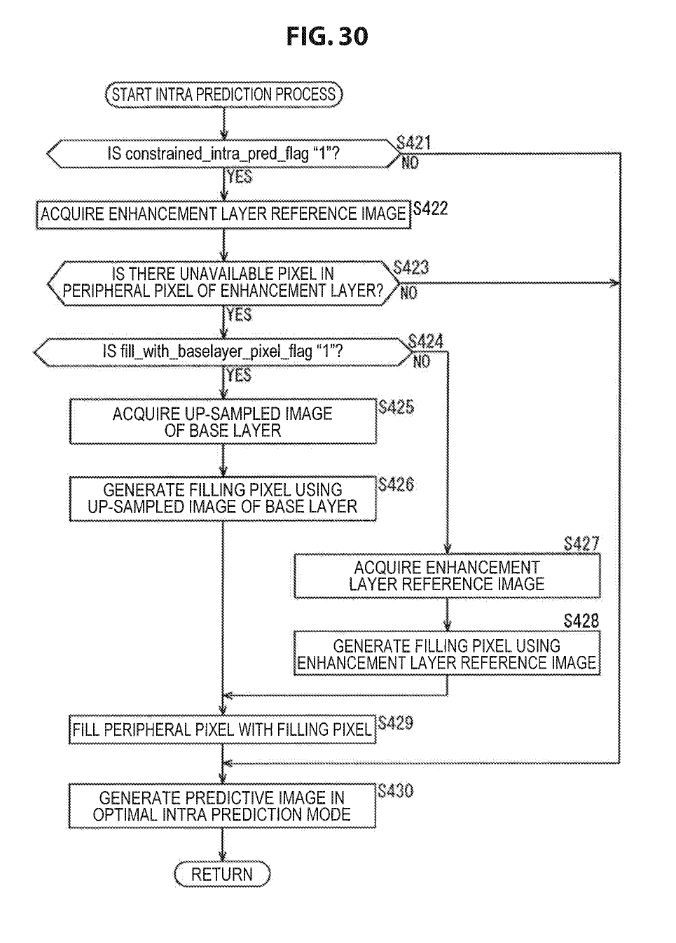

Next, an example of the flow of the intra prediction process executed in Step S402 of FIG. 29 will be described with reference to the flow chart of FIG. 30.

When the intra prediction process starts, the availability determination section 254 determines whether or not the value of the constrained intra control information (constrained_intra_pred_flag) is “1” in Step S421. When the value is determined to be “1,” the process proceeds to Step S422.

In Step S422, the availability determination section 254 acquires the enhancement layer reference image.

In Step S423, the availability determination section 254 determines the availability of peripheral pixels included in the enhancement layer reference image acquired in Step S422. In other words, the availability determination section 254 determines whether or not there is an unavailable pixel in the peripheral pixels of the enhancement layer. When it is determined that there is an unavailable pixel, the process proceeds to Step S424.

In Step S424, the filling pixel generation section 255 determines whether or not the value of the base layer pixel filling control information (fill_with_baselayer_pixel_flag) is “1.” When the value is determined to be “1,” the process proceeds to Step S425.

In Step S425, the filling pixel generation section 255 acquires the up-sampled image of the base layer.

In Step S426, the filling pixel generation section 255 generates a filling pixel using the up-sampled image of the base layer acquired from the process of Step S425. When the process of Step S426 ends, the process proceeds to Step S429.

In addition, when the value of the base layer pixel filling control information (fill_with_baselayer_pixel_flag) is determined to be “0” in Step S424, the process proceeds to Step S427.

In Step S427, the filling pixel generation section 255 acquires the enhancement layer reference image.

In Step S428, the filling pixel generation section 255 generates a filling pixel using the enhancement layer reference image acquired from the process of Step S427. When the process of Step S428 ends, the process proceeds to Step S429.

In Step S429, the filling pixel generation section 255 supplies the filling pixel generated in Step S426 or Step S428 to the intra prediction section 231 of the enhancement layer image decoding section 205, and thereby the filling pixel fills the unavailable peripheral pixel of the enhancement layer.

In Step S430, the intra prediction section 231 of the enhancement layer image decoding section 205 generates a predictive image in the optimal intra prediction mode that is the intra prediction mode employed at the time of encoding.

When the process of Step S430 ends, the intra prediction process ends, and the process returns to the process of FIG. 29.

By executing each of the processes described above, the scalable decoding device 200 can suppress a decrease in encoding efficiency and deterioration in image quality resulting from encoding and decoding.

### 3. Other

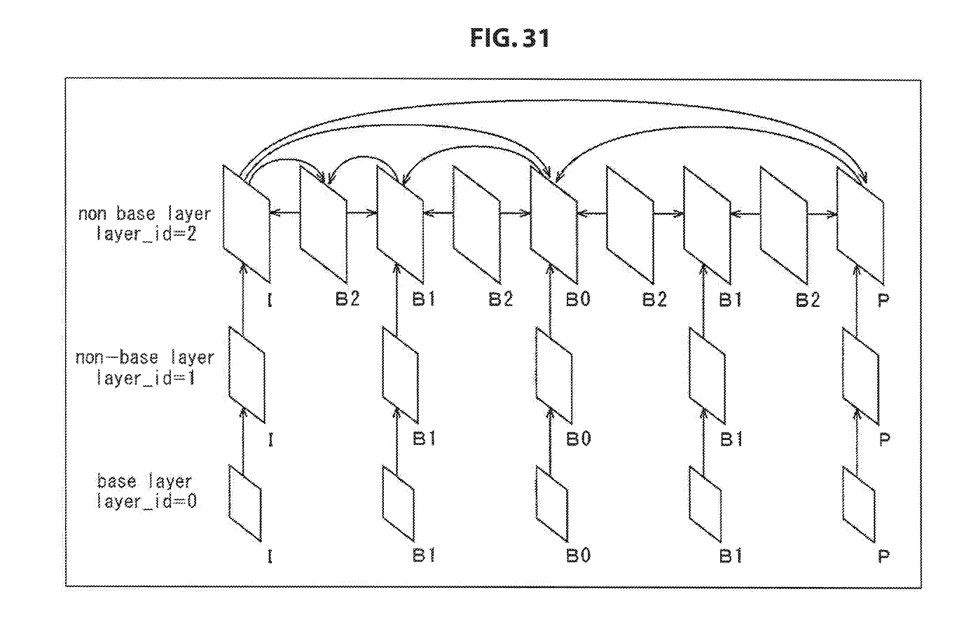

Although the example in which image data is hierarchized into a plurality of layers by scalable video coding has been described above, the number of layers is arbitrary. For example, some pictures may be hierarchized as illustrated in the example of FIG. 31. Further, although the example in which the enhancement layer is processed using information of the base layer at the time of encoding and decoding has been described above, the present technology is not limited to this example, and the enhancement layer may be processed using information of any other processed enhancement layer.

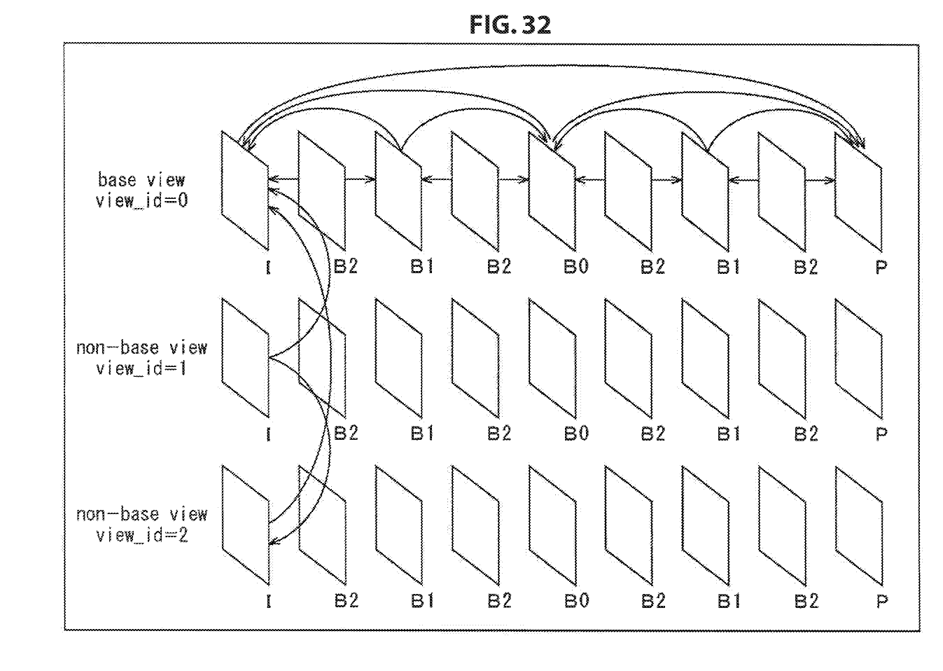

Further, a view in multi-view image encoding and decoding is also included as a layer described above. In other words, the present technology can be applied to multi-view image encoding and multi-view image decoding. FIG. 32 illustrates an example of a multi-view image encoding scheme.

As illustrated in FIG. 32, a multi-view image includes images of a plurality of views, and an image of one predetermined view among the plurality of views is designated as an image of a base view. Images of respective views other than the image of the base view are treated as image of non-base views.

When a multi-view image as in FIG. 32 is encoded and decoded, images of respective views are encoded and decoded, but the above-described method may be applied to encoding and decoding of the respective views. In other words, motion information and the like may be set to be shared for a plurality of views in such multi-view encoding and decoding.

For example, for the base view, a candidate for predictive motion information may be set to be generated using only motion information of the very view, and for non-base views, predictive motion information may be set to be generated also using motion information of the base view.

With the operation, a decrease in encoding efficiency can be suppressed also in multi-view encoding and decoding as in the above described hierarchical encoding and decoding.

As described above, the present technology can be applied to all image encoding devices and all image decoding devices based on scalable encoding and decoding.

For example, the present technology can be applied to an image encoding device and an image decoding device used when image information (bitstream) compressed by an orthogonal transform such as a discrete cosine transform and motion compensation as in MPEG and H.26x is received via a network medium such as satellite broadcasting, cable television, the Internet, or a mobile telephone. Further, the present technology can be applied to an image encoding device and an image decoding device used when processing is performed on a storage medium such as an optical disc, a magnetic disk, or a flash memory.

### 4. Third Embodiment

<Computer>

The above described series of processes can be executed by hardware or can be executed by software. When the series of processes are to he performed by software, the programs forming the software are installed into a computer. Here, a computer includes a computer which is incorporated in dedicated hardware or a general-purpose personal computer (PC) which can execute various functions by installing various programs into the computer, for example.

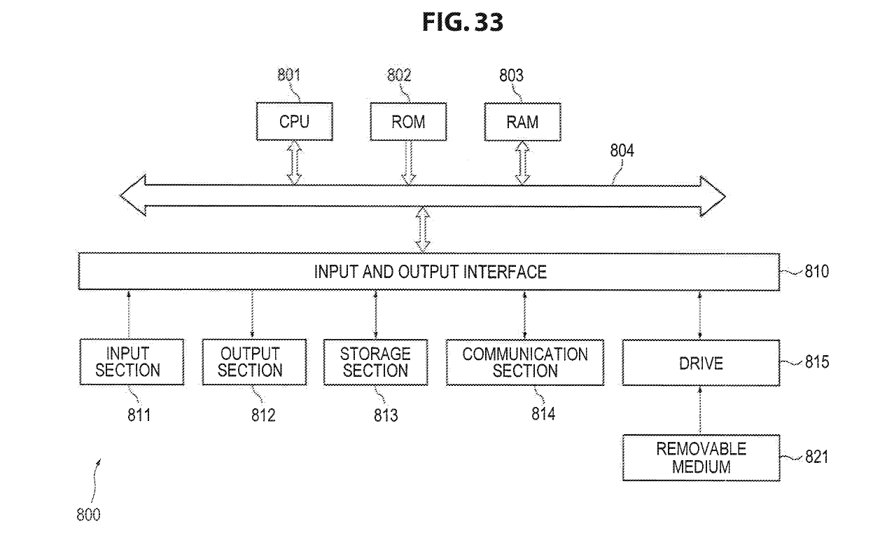

FIG. 33 is a block, diagram illustrating a configuration example of hardware of a computer for executing the above-described series of processes through a program.

In a computer 800 shown in FIG. 33, a central processing unit (CPU) 801, a read only memory (ROM) 802, and a random access memory (RAM) 803 are connected to one another by a bus 804.

An input and output interface (I/F) 810 is further connected to the bus 804. An input section 811, an output section 812, a storage section 813, a communication section 814, and a drive 815 are connected to the input and output 810.

The input section 811 is formed with a keyboard, a mouse, a microphone, a touch panel, an input terminal, and the like. The output section 812 is formed with a display, a speaker, an output terminal, and the like. The storage section 813 is formed with a hard disk, a nonvolatile memory, or the like. The communication section 814 is formed with a network interface or the like. The drive 815 drives a removable medium 821 such as a magnetic disk, an optical disk, a magneto-optical disk, or a semiconductor memory.

In the computer configured as described above, the CPU 801 loads the programs stored in the storage section 813 into the RAM 803 via the input and output I/F 810 and the bus 804, and executes the programs, so that the above described series of processes are performed. The RAM 803 also stores data necessary for the CPU 801 to execute the various processes.

The program executed by the computer 800 (the CPU 801) may be provided by being recorded on the removable medium 821 as a packaged medium or the like. The program can also be applied via a wired or wireless transfer medium, such as a local area network, the Internet, or a digital satellite broadcast.

In the computer, by loading the removable medium 821 into the drive 815, the program can be installed into the storage section 813 via the input and output I/F 810. It is also possible to receive the program from a wired or wireless transfer medium using the communication section 814 and install the program into the storage section 813. As another alternative, the program can be installed in advance into the ROM 802 or the storage section 813.

It should be noted that the program executed by a computer may be a program that is processed in time series according to the sequence described in this specification or a program that is processed in parallel or at necessary timing such as upon calling.

In the present disclosure, steps of describing the program to be recorded on the recording medium may include processing performed in time-series according to the description order and processing not processed in time-series but performed in parallel or individually.

In addition, in this disclosure, a system means a set of a plurality of elements (devices, modules (parts), or the like) regardless of whether or not all elements are arranged in a single housing. Thus, both a plurality of devices that are accommodated in separate housings and connected via a network and a single device in which a plurality of modules are accommodated in a single housing are systems.

Further, an element described as a single device (or processing unit) above may be divided and configured as a plurality of devices (or processing units). On the contrary, elements described as a plurality of devices (or processing units) above may be configured collectively as a single device (or processing unit). Further, an element other than those described above may be added to each device (or processing unit). Furthermore, a part of an element of a given device (or processing unit) may be included in an element of another device (or another processing unit) as long as the configuration or operation of the system as a whole is substantially the same.

The preferred embodiments of the present disclosure have been described above with reference to the accompanying drawings, whilst the present invention is not limited to the above examples, of course. A person skilled in the art may find various alterations and modifications within the scope of the appended claims, and it should be understood that they will naturally come under the technical scope of the present disclosure.

For example, the present disclosure can adopt a configuration of cloud computing which processes by allocating and connecting one function by a plurality of apparatuses through a network.

Further, each step described by the above mentioned flow charts can be executed by one apparatus or by allocating a plurality of apparatuses.

In addition, in the case where a plurality of processes is included in one step, the plurality of processes included in this one step can be executed by one apparatus or by allocating a plurality of apparatuses.

The image encoding device and the image decoding device according to the embodiment may be applied to various electronic devices such as transmitters and receivers for satellite broadcasting, cable broadcasting such as cable TV, distribution on the Internet, distribution to terminals via cellular communication and the like, recording devices that record images in a medium such as optical discs, magnetic disks and flash memory, and reproduction devices that reproduce images from such storage medium. Four applications will be described below.

### 5. Applications

### <First Application: Television Receivers>

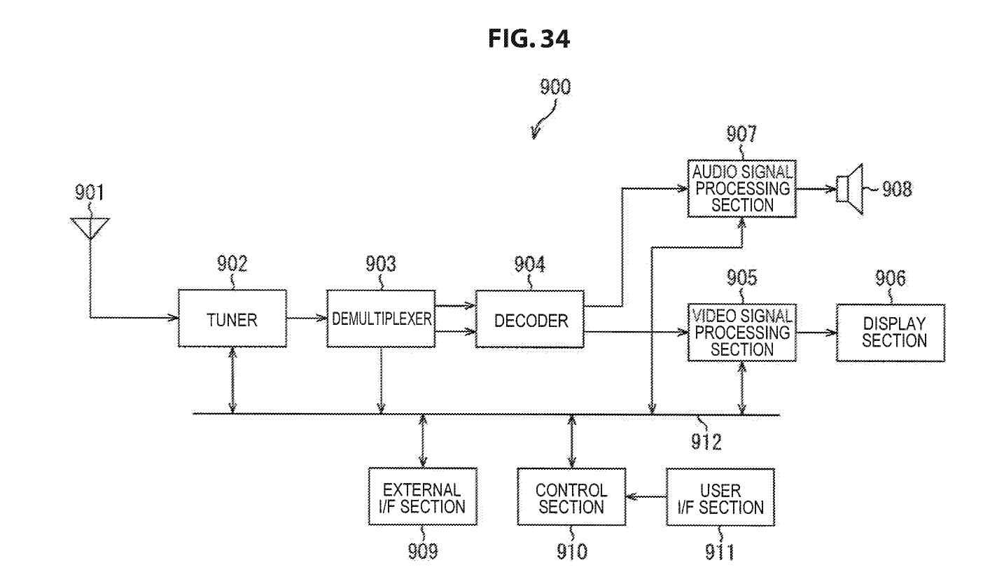

FIG. 34 illustrates an example of a schematic configuration of a television device to which the embodiment is applied, A television device 900 includes an antenna 901, a tuner 902, a demultiplexer 903, a decoder 904, an video signal processing section 905, a display section 906, an audio signal processing section 907, a speaker 908, an external I/F 909, a control section 910, a user I/F 911, and a bus 912.

The tuner 902 extracts a signal of a desired channel from broadcast signals received via the antenna 901, and demodulates the extracted signal. The tuner 902 then outputs an encoded bitstream obtained through the demodulation to the demultiplexer 903. That is, the tuner 902 serves as a transmission unit of the television device 900 for receiving an encoded stream in which an image is encoded.

The demultiplexer 903 demultiplexes the encoded bitstream to obtain a video stream and an audio stream of a program to be viewed, and outputs each stream obtained through the demultiplexing to the decoder 904. The demultiplexer 903 also extracts auxiliary data such as electronic program guides (EPGs) from the encoded bitstream, and supplies the extracted data to the control section 910. Additionally, the demultiplexer 903 may perform descrambling when the encoded bitstream has been scrambled.

The decoder 904 decodes the video stream and the audio stream input from the demultiplexer 903. The decoder 904 then outputs video data generated in the decoding process to the video signal processing section 905. The decoder 904 also outputs the audio data generated in the decoding process to the audio signal processing section 907.

The video signal processing section 905 reproduces the video data input from the decoder 904, and causes the display section 906 to display the video. The video signal processing section 905 may also cause the display section 906 to display an application screen supplied via a network, Further, the video signal processing section 905 may perform an additional process such as noise removal, for example, on the video data in accordance with the setting. Furthermore, the video signal processing section 905 may generate an image of a graphical user I/F (GUI) such as a menu, a button and a cursor, and superimpose the generated image on an output image.

The display section 906 is driven by a drive signal supplied from the video signal processing section 905, and displays a video or an image on a video screen of a display device (e.g. liquid crystal display, plasma display, organic electrioluminescence display ((OLED), etc.).

The audio signal processing section 907 performs a reproduction process such as D/A conversion and amplification on the audio data input from the decoder 904, and outputs a sound from the speaker 908. The audio signal processing section 907 may also perform an additional process such as noise removal on the audio data.

The external I/F 909 is an I/F for connecting the television device 900 to an external device or a network. For example, a video stream or an audio stream received via the external I/F 909 may be decoded by the decoder 904. That is, the external I/F 909 also serves as a transmission unit of the television device 900 for receiving an encoded stream in which an image is encoded.

The control section 910 includes a processor such as a central processing unit (CPU), and a memory such as random access memory (RAM) and read only memory (ROM). The memory stores a program to be executed by the CPU, program data, EPG data, data acquired via a network, and the like. The program stored in the memory is read out and executed by the CPU at the time of activation of the television device 900, for example. The CPU controls the operation of the television device 900, for example, in accordance with an operation signal input from the user I/F 911 by executing the program.

The user I/F 911 is connected to the control section 910. The user I/F 911 includes, for example, a button and a switch used for a user to operate the television device 900, and a receiving section for a remote control signal. The user I/F 911 detects an operation of a user via these structural elements, generates an operation signal, and outputs the generated operation signal to the control section 910.

The bus 912 connects the tuner 902, the demultiplexer 903, the decoder 904, the video signal processing section 905, the audio signal processing section 907, the external I/F 909, and the control section 910 to each other.

The decoder 904 has a function of the scalable decoding device 200 according to the embodiment in the television device 900 configured in this manner. Therefore, when images are decoded in the television device 900, suppression of a decrease in encoding efficiency and deterioration in image quality resulting from encoding and decoding can be realized.

### <Second Application: Mobile Phones>

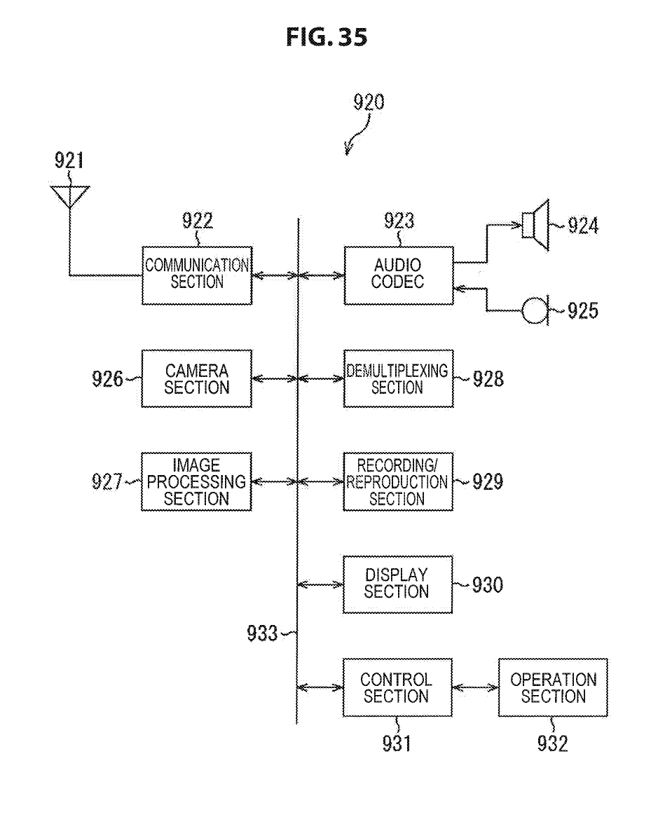

FIG. 35 illustrates an example of a schematic configuration of a mobile phone to which the embodiment is applied. A mobile phone 920 includes an antenna 921, a communication section 922, an audio codec 923, a speaker 924, a microphone 925, a camera section 926, an image processing section 927, a demultiplexing section 928, a recording/reproduction section 929, a display section 930, a control section 931, an operation section 932, and a bus 933.

The antenna 921 is connected to the communication section 922. The speaker 924 and the microphone 925 are connected to the audio codec 923. The operation section 932 is connected to the control section 931. The bus 933 connects the communication section 922, the audio codec 923, the camera section 926, the image processing section 927, the demultiplexing section 928, the recording/reproduction section 929, the display section 930, and the control section 931 to each other.

The mobile phone 920 performs an operation such as transmission and reception of an audio signal, transmission and reception of email or image data, image capturing, and recording of data in various operation modes including an audio call mode, a data communication mode, an image capturing mode, and a videophone mode.

An analogue audio signal generated by the microphone 925 is supplied to the audio codec 923 in the audio call mode. The audio codec 923 converts the analogue audio signal into audio data, has the converted audio data subjected to the A/D conversion, and compresses the converted data. The audio codec 923 then outputs the compressed audio data to the communication section 922. The communication section 922 encodes and modulates the audio data, and generates a transmission signal. The communication section 922 then transmits the generated transmission signal to a base station (not illustrated) via the antenna 921. The communication section 922 also amplifies a wireless signal received via the antenna 921 and converts the frequency of the wireless signal to acquire a received signal. The communication section 922 then demodulates and decodes the received signal, generates audio data, and outputs the generated audio data to the audio codec 923. The audio codec 923 extends the audio data, has the audio data subjected to the D/A conversion, and generates an analogue audio signal. The audio codec 923 then supplies the generated audio signal to the speaker 924 to output a sound.

The control section 931 also generates text data in accordance with an operation made by a user via the operation section 932, the text data, for example, composing email. Moreover, the control section 931 causes the display section 930 to display the text. Furthermore, the control section 931 generates email data in accordance with a transmission instruction from a user via the operation section 932, and outputs the generated email data to the communication section 922. The communication section 922 encodes and modulates the email data, and generates a transmission signal. The communication section 922 then transmits the generated transmission signal to a base station (not illustrated) via the antenna 921. The communication section 922 also amplifies a wireless signal received via the antenna 921 and converts the frequency of the wireless signal to acquire a received signal. The communication section 922 then demodulates and decodes the received signal to restore the email data, and outputs the restored email data to the control section 931. The control section 931 causes the display section 930 to display the content of the email, and also causes the storage medium of the recording/reproduction section 929 to store the email data.

The recording/reproduction section 929 includes a readable and writable storage medium. For example, the storage medium may be a built-in storage medium such as RAM and flash memory, or an externally mounted storage medium such as hard disks, magnetic disks, magneto-optical disks, optical discs, unallocated space bitmap (USB) memory, and memory cards.

Furthermore, the camera section 926, for example, captures an image of a subject to generate image data, and outputs the generated image data to the image processing section 927 in the image capturing mode. The image processing section 927 encodes the image data input from the camera section 926, and causes the storage medium of the storage/reproduction section 929 to store the encoded stream.

Furthermore, the demultiplexing section 928, for example, multiplexes a video stream encoded by the image processing section 927 and an audio stream input from the audio codec 923, and outputs the multiplexed stream to the communication section 922 in the videophone mode. The communication section 922 encodes and modulates the stream, and generates a transmission signal. The communication section 922 then transmits the generated transmission signal to a base station (not illustrated) via the antenna 921. The communication section 922 also amplifies a wireless signal received via the antenna 921 and converts the frequency of the wireless signal to acquire a received signal. These transmission signal and received signal may include an encoded bitstream. The communication section 922 then demodulates and decodes the received signal to restore the stream, and outputs the restored stream to the demultiplexing section 928. The demultiplexing section 928 demultiplexes the input stream to obltain a video stream and an audio stream, and outputs the video stream to the image processing section 927 and the audio stream to the audio codec 923. The image processing section 927 decodes the video stream, and generates video data. The video data is supplied to the display section 930, and a series of images is displayed by the display section 930. The audio codec 923 extends the audio stream, has the audio stream subjected to the D/A conversion, and generates an analogue audio signal. The audio codec 923 then supplies the generated audio signal to the speaker 924, and causes a sound to be output.

The image processing section 927 has functions of the scalable encoding device 100 and the scalable decoding device 200 according to the embodiment in the mobile phone 920 configured in this manner. Therefore, when images are encoded and decoded in the mobile phone 920, a decrease in encoding efficiency and deterioration in image quality resulting from encoding and decoding can be suppressed.

### <Third Application: Recording/Reproduction Device>

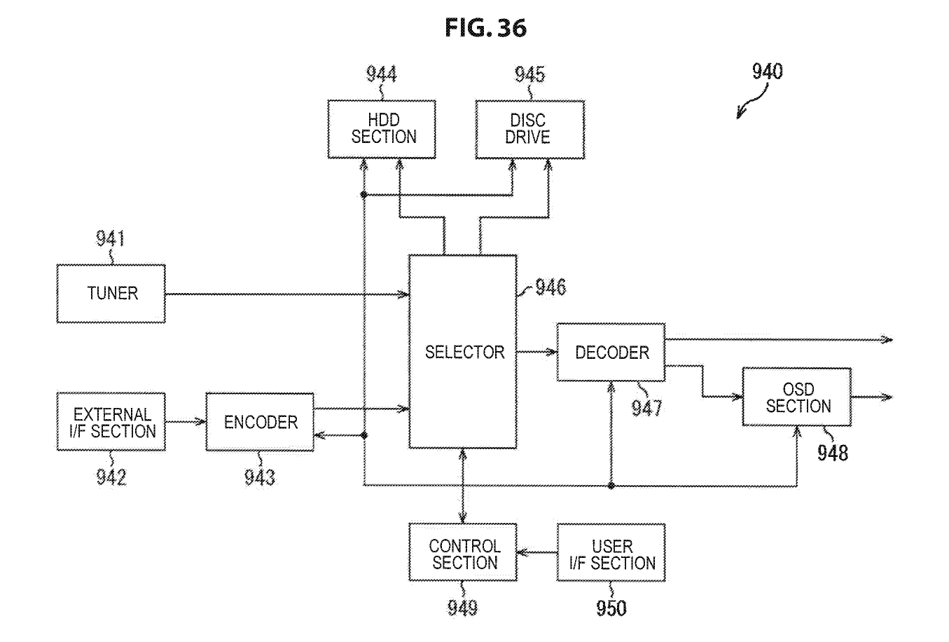

FIG. 36 illustrates an example of a schematic configuration of a recording/reproduction device to which the embodiment is applied. A recording/reproduction device 940, for example, encodes audio data and video data of a received broadcast program and records the encoded audio data and the encoded video data in a recording medium. For example, the recording/reproduction device 940 may also encode audio data and video data acquired from another device and record the encoded audio data and the encoded video data in a recording medium. Furthermore, the recording/reproduction device 940, for example, uses a monitor or a speaker to reproduce the data recorded in the recording medium in accordance with an instruction of a user. At this time, the recording/reproduction device 940 decodes the audio data and the video data.

The recording/reproduction device 940 includes a tuner 941, an external I/F 942, an encoder 943, a hard disk drive (HDD) 944, a disc drive 945, a selector 946, a decoder 947, an on-screen display (OSD) 948, a control section 949, and a user I/F 950.

The tuner 941 extracts a signal of a desired channel from broadcast signals received via an antenna (not shown), and demodulates the extracted signal. The tuner 941 then outputs an encoded bitstream obtained through the demodulation to the selector 946. That is, the tuner 941 serves as a transmission unit of the recording/reproduction device 940.

The external I/F 942 is an I/F for connecting the recording/reproduction device 940 to an external device or a network. For example, the external I/F 942 may be an Institute of Electrical and Electronics Engineers (IEEE) 1394 I/F, a network an USB I/F, a flash memory I/F, or the like. For example, video data and audio data received via the external I/F 942 are input to the encoder 943. That is, the external I/F 942 serves as a transmission unit of the recording/reproduction device 940.

When the video data and the audio data input from the external I/F 942 have not been encoded, the encoder 943 encodes the video data and the audio data. The encoder 943 then outputs an encoded bitstream to the selector 946.

The HDD 944 records, in an internal hard disk, the encoded bitstream in which content data of a video and a sound is compressed, various programs, and other pieces of data. The HDD 944 also reads out these pieces of data from the hard disk at the time of reproducing a video or a sound.

The disc drive 945 records and reads out data in a recording medium that is mounted. The recording medium that is mounted on the disc drive 945 may be, for example, a DVD disc (DVD-Video, DVD-RAM, DVD-R, DVD−RW, a DVD+R, DVD+RW, etc.), a Blu-ray (registered trademark) disc, or the like.

The selector 946 selects, at the time of recording a video or a sound, an encoded bitstream input from the tuner 941 or the encoder 943, and outputs the selected encoded bitstream to the HDL) 944 or the disc drive 945. The selector 946 also outputs, at the time of reproducing a video or a sound, an encoded bitstream input from the HDD 944 or the disc drive 945 to the decoder 947.

The decoder 947 decodes the encoded bitstream, and generates video data and audio data. The decoder 947 then outputs the generated video data to the OSD 948. The decoder 904 also outputs the generated audio data to an external speaker.

The OSD 948 reproduces the video data input from the decoder 947, and displays a video. The OSD 948 may also superimpose an image of a GUI such as a menu, a button, and a cursor on a displayed video.

The control section 949 includes a processor such as a CPU, and a memory such as RAM and ROM. The memory stores a program to be executed by the CPU, program data, and the like. For example, a program stored in the memory is read out and executed by the CPU at the time of activation of the recording/reproduction device 940. The CPU controls the operation of the recording/reproduction device 940, for example, in accordance with an operation signal input from the user I/F 950 by executing the program.

The user I/F 950 is connected to the control section 949. The user I/F 950 includes, for example, a button and a switch used for a user to operate the recording/reproduction device 940, and a receiving section for a remote control signal. The user I/F 950 detects an operation made by a user via these structural elements, generates an operation signal, and outputs the generated operation signal to the control section 949.

The encoder 943 has a function of the scalable encoding device 100 according to the embodiment in the recording/reproduction device 940 configured in this manner. The decoder 947 also has a function of the scalable decoding device 200 according to the embodiment. Therefore, when images are encoded and decoded in the recording/reproduction device 940, a decrease in encoding efficiency and deterioration in image quality resulting from encoding and decoding can be suppressed.

### <Fourth Application: Image Capturing Device>

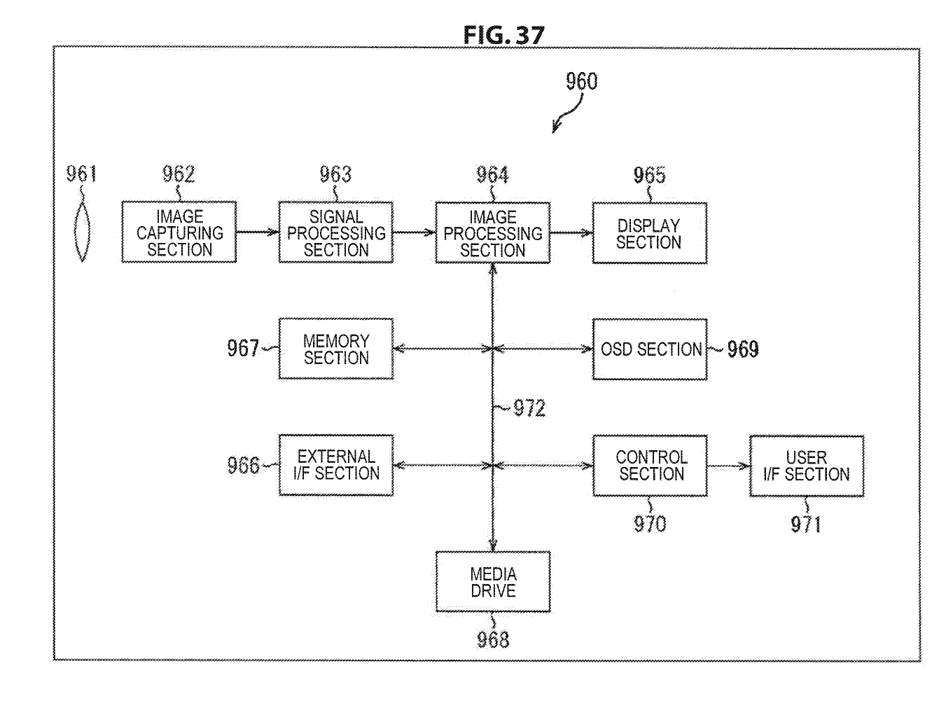

FIG. 37 illustrates an example of a schematic configuration of an image capturing device to which the embodiment is applied. An image capturing device 960 captures an image of a subject to generate an image, encodes the image data, and records the image data in a recording medium.

The image capturing device 960 includes an optical block 961, an image capturing section 962, a signal processing section 963, an image processing section 964, a display section 965, an external I/F 966, a memory 967, a media drive 968, an OSD 969, a control section 970, a user I/F 971, and a bus 972.

The optical block 961 is connected to the image capturing section 962. The image capturing section 962 is connected to the signal processing section 963. The display section 965 is connected to the image processing section 964. The user I/F 971 is connected to the control section 970. The bus 972 connects the image processing section 964, the external I/F 966, the memory 967, the media drive 968, the OSD 969, and the control section 970 to each other.

The optical block 961 includes a focus lens, an aperture stop mechanism, and the like. The optical block 961 forms an optical image of a subject on an image capturing surface of the image capturing section 962. The image capturing section 962 includes an image sensor such as a charge coupled device (CCD) and a complementary metal oxide semiconductor (CMOS), and converts the optical image formed on the image capturing surface into an image signal which is an electrical signal through photoelectric conversion. The image capturing section 962 then outputs the image signal to the signal processing section 963.

The signal processing section 963 performs various camera signal processes such as knee correction, gamma correction, and color correction on the image signal input from the image capturing section 962. The signal processing section 963 outputs the image data subjected to the camera signal process to the image processing section 964.

The image processing section 964 encodes the image data input from the signal processing section 963, and generates encoded data. The image processing section 964 then outputs the generated encoded data to the external I/F 966 or the media drive 963. The image processing section 964 also decodes encoded data input from the external I/F 966 or the media drive 968, and generates image data. The image processing section 964 then outputs the generated image data to the display section 965. The image processing section 964 may also output the image data input from the signal processing section 963 to the display section 965, and cause the image to he displayed. Furthermore, the image processing section 964 may superimpose data for display acquired from the OSD 969 on an image to be output to the display section 965.

The OSD 969 generates an image of a GUI such as a menu, a button, and a cursor, and outputs the generated image to the image processing section 964.

The external I/F 966 is configured, for example, as an USB input and output terminal. The external I/F 966 connects the image capturing device 960 and a printer, for example, at the time of printing an image. A drive is further connected to the external I/F 966 as needed. A removable medium such as magnetic disks and optical discs is mounted on the drive, and a program read out from the removable medium may be installed in the image capturing device 960. Furthermore, the external I/F 966 may be configured as a network I/F to be connected to a network such as a LAN and the Internet. That is, the external I/F 966 serves as a transmission unit of the image capturing device 960.

A recording medium to be mounted on the media drive 968 may be a readable and writable removable medium such as magnetic disks, magneto-optical disks, optical discs, and semiconductor memory. The recording medium may also be fixedly mounted on the media drive 968, configuring a non-transportable storage section such as built-in hard disk drives or a solid state drives (SSDs).

The control section 970 includes a processor such as a CPU, and a memory such as RAM and ROM. The memory stores a program to be executed by the CPU, program data, and the like. A program stored in the memory is read out and executed by the CPU, for example, at the time of activation of the image capturing device 960. The CPU controls the operation of the image capturing device 960, for example, in accordance with an operation signal input from the user I/F 971 by executing the program.

The user I/F 971 is connected to the control section 970. The user I/F 971 includes, for example, a button, a switch, and the like used for a user to operate the image capturing device 960. The user I/F 971 detects an operation made by a user via these structural elements, generates an operation signal, and outputs the generated operation signal to the control section 970.

The image processing section 964 has a function of the scalable encoding device 100 and the scalable decoding device 200 according to the embodiment in the image capturing device 960 configured in this manner. Therefore, when images are encoded and decoded in the image capturing device 960, a decrease in encoding efficiency and deterioration in image quality resulting from encoding and decoding can be suppressed.

### 6. Application Example of Scalable Video Coding

<First System>

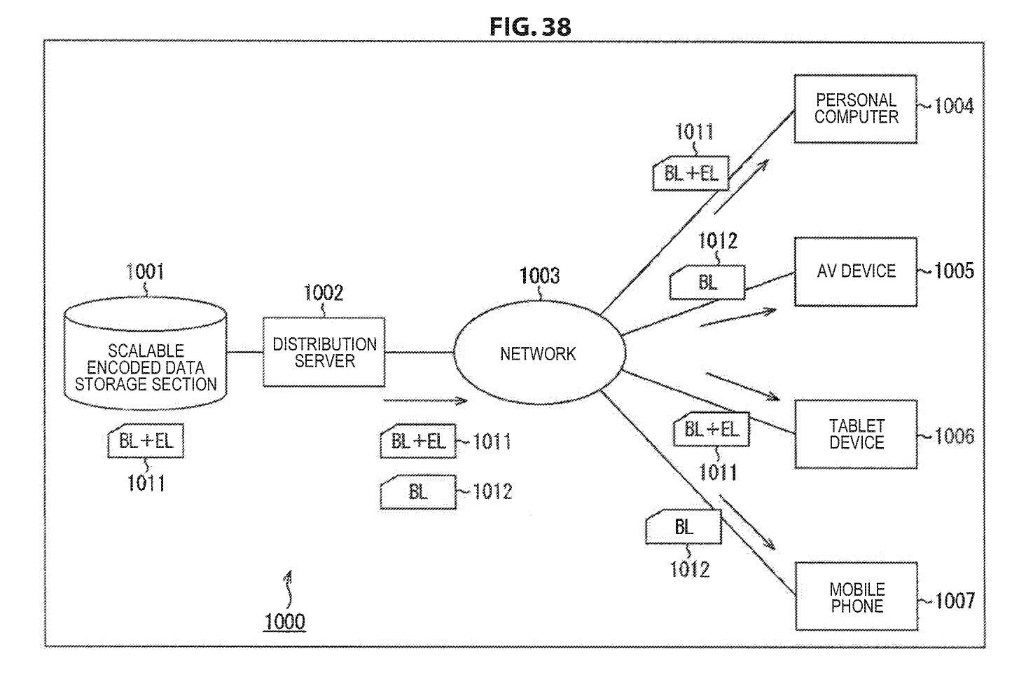

Next, a specific example of using scalable encoded data, in which a scalable video coding (hierarchical coding) is performed, will be described. The scalable video coding, for example, is used for selection of data to be transmitted as examples illustrated in FIG. 38.

In a data transmission system 1000 illustrated in FIG. 38, a distribution server 1002 reads scalable encoded data stored in a scalable encoded data storage section 1001, and distributes the scalable encoded data to a terminal device such as a PC 1004, an AV device 1005, a tablet device 1006, or a mobile phone 1007 via a network 1003.

At this time, the distribution server 1002 selects and transmits encoded data having proper quality according to capability of the terminal device, communication environment, or the like. Even when the distribution server 1002 transmits unnecessarily high-quality data, a high-quality image is not necessarily obtainable in the terminal device and it may be a cause of occurrence of a delay or an overflow. In addition, a communication band may be unnecessarily occupied or a load of the terminal device may be unnecessarily increased. In contrast, even when the distribution server 1002 transmits unnecessarily low quality data, an image with a sufficient quality may not be obtained. Thus, the distribution server 1002 appropriately reads and transmits the scalable encoded data stored in the scalable encoded data storage section 1001 as the encoded data having a proper quality according to the capability of the terminal device, the communication environment, or the like.

For example, the scalable encoded data storage section 1001 is configured to store scalable encoded data (BL+EL) 1011 in which the scalable video coding is performed. The scalable encoded data (BL+EL) 1011 is encoded data including both a base layer and an enhancement layer, and is data from which a base layer image and an enhancement layer image can be obtained by performing decoding.

The distribution server 1002 selects an appropriate layer according to the capability of the terminal device for transmitting data, the communication environment, or the like, and reads the data of the selected layer. For example, with respect to the PC 1004 or the tablet device 1006 having high processing capability, the distribution server 1002 reads the scalable encoded data (BL+EL) 1011 from the scalable encoded data storage section 1001, and transmits the scalable encoded data (BL+EL) 1011 without change. On the other hand, for example, with respect to the AV device 1005 or the mobile phone 1007 having low processing capability, the distribution server 1002 extracts the data of the base layer from the scalable encoded data (BL+EL) 1011, and transmits the extracted data of the base layer as low quality scalable encoded data (BL) 1012 that is data having the same content as the scalable encoded data (BL+EL) 1011 but has lower quality than the scalable encoded data (BL+EL) 1011.

Because an amount of data can easily be adjusted by employing the scalable encoded data, the occurrence of the delay or the overflow can be suppressed or the unnecessary increase of the load of the terminal device or the communication media can be suppressed. In addition, because a redundancy between the layers is reduced in the scalable encoded data (BL+EL) 1011, it is possible to further reduce the amount of data than when the encoded data of each layer is treated as the individual data. Therefore, it is possible to more efficiently use the storage region of the scalable encoded data storage section 1001.

Because various devices such as the PC 1004 to the mobile phone 1007 are applicable as the terminal device, the hardware performance of the terminal devices differs according to the device. In addition, because there are various applications which are executed by the terminal device, the software performance thereof also varies. Further, because all the communication networks including a wired, wireless, or both such as the Internet and the local area network (LAN) are applicable as the network 1003 serving as a communication medium, the data transmission performance thereof varies. Further, the data transmission performance may vary by other communications, or the like.

Therefore, the distribution server 1002 may perform communication with the terminal device which is the data transmission destination before starting the data transmission, and then obtain information related to the terminal device performance such as hardware performance of the terminal device, or the application (software) performance which is executed by the terminal device, and information related to the communication environment such as an available bandwidth of the network 1003. Then, distribution server 1002 may select an appropriate layer based on the obtained information.

Also, the extraction of the layer may be performed in the terminal device. For example, the PC 1004 may decode the transmitted scalable encoded data (BL+EL) 1011 and display the image of the base layer or display the image of the enhancement layer. In addition, for example, the PC 1004 may be configured to extract the scalable encoded data (BL) 1012 of the base layer from the transmitted scalable encoded data (BL+EL) 1011, store the extracted scalable encoded data (BL) 1012 of the base layer, transmit to another device, or decode and display the image of the base layer.

Of course, the number of the scalable encoded data storage sections 1001, the distribution servers 1002, the networks 1003, and the terminal devices are optional. In addition, although the example of the distribution server 1002 transmitting the data to the terminal device is described above, the example of use is not limited thereto. The data transmission system 1000 is applicable to any system which selects and transmits an appropriate layer according to the capability of the terminal device, the communication environment, or the like when the scalable encoded data is transmitted to the terminal device.

In addition, as the present technology is applied to the data transmission system 1000 described above in the same manner as the application to the hierarchical encoding and hierarchical decoding described above in the first and second embodiments, the same effects as those of the first and second embodiments can be obtained.

<Second System>

In addition, the scalable video coding, for example, is used for transmission via a plurality of communication media as in an example illustrated in FIG, 39.

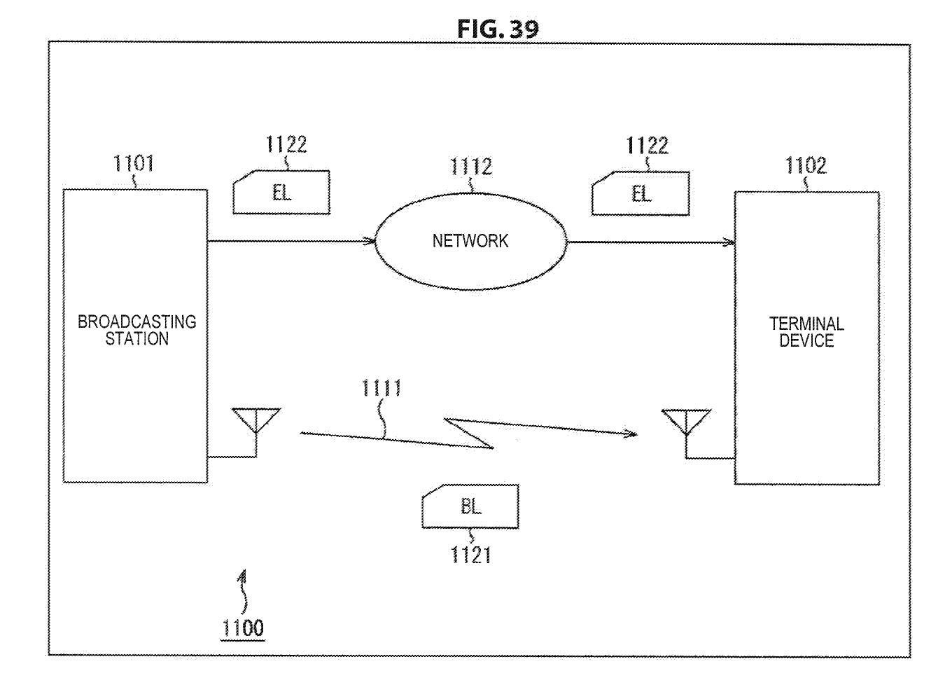

In a data transmission system 1100 illustrated in FIG. 39, a broadcasting station 1101 transmits scalable encoded data (BL) 1121 of the base layer by terrestrial broadcasting 1111. In addition, the broadcasting station 1101 transmits scalable encoded data (EL) 1122 of the enhancement layer via any arbitrary network 1112 made of a communication network that is wired, wireless, or both (for example, the data is packetized and transmitted).

A terminal device 1102 has a function of receiving the terrestrial broadcasting 1111 that is broadcast by the broadcasting station 1101 and receives the scalable encoded data (BL) 1121 of the base layer transmitted via the terrestrial broadcasting 1111. In addition, the terminal device 1102 further has a communication function by which the communication is performed via the network 1112, and receives the scalable encoded data (EL) 1122 of the enhancement layer transmitted via the network 1112.

For example, according to a user's instruction or the like, the terminal device 1102 decodes the scalable encoded data (BL) 1121 of the base layer acquired via the terrestrial broadcasting 1111, thereby obtaining or storing the image of the base layer or transmitting the image of the base layer to other devices.

In addition, for example, according to the user's instruction, the terminal device 1102 combines the scalable encoded data (BL) 1121 of the base layer acquired via the terrestrial broadcasting 1111 and the scalable encoded data (EL) 1122 of the enhancement layer acquired via the network 1112, thereby obtaining the scalable encoded data (BL+EL), obtaining or storing the image of the enhancement layer by decoding the scalable encoded data (BL+EL), or transmitting the image of the enhancement layer to other devices.

As described above, the scalable encoded data, for example, can be transmitted via the different communication medium for each layer. Therefore, it is possible to disperse the load and suppress the occurrence of the delay or the overflow.

In addition, according to the situation, the communication medium used for the transmission for each layer may be configured to be selected. For example, the scalable encoded data (BL) 1121 of the base layer in which the amount of data is comparatively large may be transmitted via the communication medium having a wide bandwidth, and the scalable encoded data (EL) 1122 of the enhancement layer in which the amount of data is comparatively small may be transmitted via the communication media having a narrow bandwidth. In addition, for example, whether the communication medium that transmits the scalable encoded data (EL) 1122 of the enhancement layer is the network 1112 or the terrestrial broadcasting 1111 may be switched according to the available bandwidth of the network 1112. Of course, the same is true for data of an arbitrary layer.

By controlling in this way, it is possible to further suppress the increase of the load in the data transmission.

Of course, the number of the layers is optional, and the number of communication media used in the transmission is also optional. In addition, the number of terminal devices 1102 which are the destination of the data distribution is also optional. Further, although the example of the broadcasting from the broadcasting station 1101 has been described above, the use example is not limited thereto. The data transmission system 1100 can be applied to any system which divides the scalable encoded data using a layer as a unit and transmits the scalable encoded data via a plurality of links.

In addition, as the present technology is applied to the data transmission system 1100 described above in the same manner as the application to the hierarchical encoding and hierarchical decoding described above in the first and second embodiments, the same effects as those of the first and second embodiments can be obtained.

<Third System>

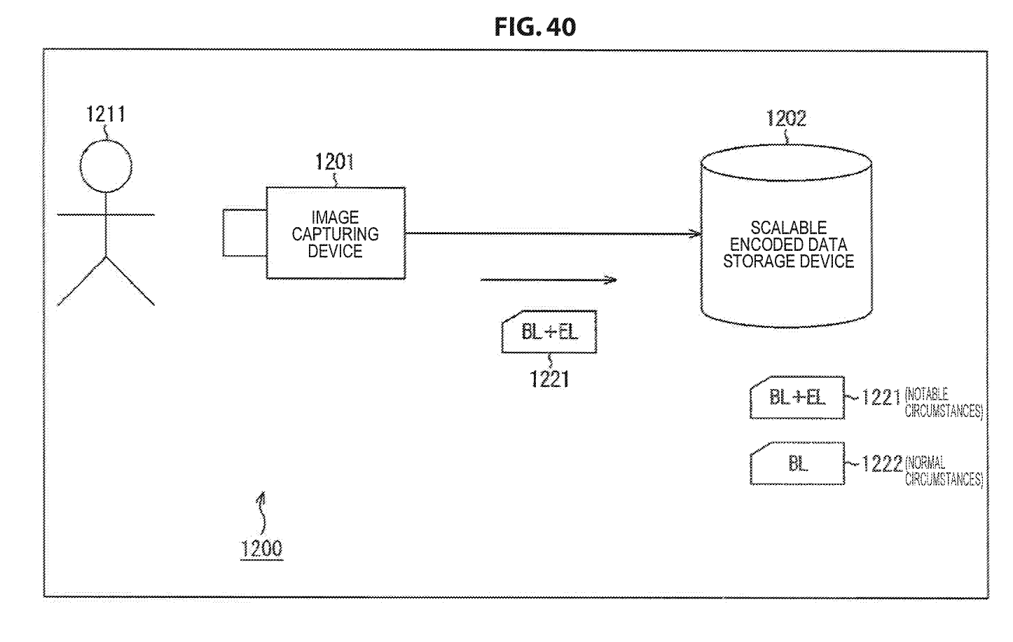

In addition, the scalable video coding is used in the storage of the encoded data as an example illustrated in FIG. 40.

In an image capturing system 1200 illustrated in FIG. 40, an image capturing device 1201 performs scalable video coding on image data obtained by capturing an image of a subject 1211, and supplies a scalable video result as the scalable encoded data (BL+EL) 1221 to a scalable encoded data storage device 1202.

The scalable encoded data storage device 1202 stores the scalable encoded data (BL+EL) 1221 supplied from the image capturing device 1201 in quality according to the situation. For example, in the case of normal circumstances, the scalable encoded data storage device 1202 extracts data of the base layer from the scalable encoded data (BL+EL) 1221, and stores the extracted data as scalable encoded data (BL) 1222 of the base layer having a small amount of data at low quality. On the other hand, for example, in the case of notable circumstances, the scalable encoded data storage device 1202 stores the scalable encoded data (BL+EL) 1221 having a large amount of data at high quality without change.

In this way, because the scalable encoded data storage device 1202 can save the image at high quality only in a necessary case, it is possible to suppress the decrease of the value of the image due to the deterioration of the image quality and suppress the increase of the amount of data, and it is possible to improve the use efficiency of the storage region.

For example, the image capturing device 1201 is assumed to be a motoring camera. Because content of the captured image is unlikely to be important when a monitoring subject (for example, an invader) is not shown in the imaged image (in the case of the normal circumstances), the priority is on the reduction of the amount of data, and the image data (scalable encoded data) is stored at low quality. On the other hand, because the content of the imaged image is likely to be important when a monitoring target is shown as the subject 1211 in the imaged image (in the case of the notable circumstances), the priority is on the image quality, and the image data (scalable encoded data) is stored at high quality.

For example, whether the case is the case of the normal circumstances or the notable circumstances may he determined by the scalable encoded data storage device 1202 by analyzing the image. In addition, the image capturing device 1201 may be configured to make the determination and transmit the determination result to the scalable encoded data storage device 1202.

A determination criterion of whether the case is the case of the normal circumstances or the notable circumstances is optional and the content of the image which is the determination criterion is optional. Of course, a condition other than the content of the image can be designated as the determination criterion. For example, switching may be configured to be performed according to the magnitude or waveform of recorded sound, by a predetermined time interval, or by an external instruction such as the user's instruction.

In addition, although the two states of the normal circumstances and the notable circumstances have been described above, the number of the states is optional, and for example, switching may be configured to be performed among three or more states such as normal circumstances, slightly notable circumstances, notable circumstances, and highly notable circumstances. However, the upper limit number of states to be switched depends upon the number of layers of the scalable encoded data.

In addition, the image capturing device 1201 may determine the number of layers of the scalable video coding according to the state. For example, in the case of the normal circumstances, the image capturing device 1201 may generate the scalable encoded data (BL) 1222 of the base layer having a small amount of data at low quality and supply the data to the scalable encoded data storage device 1202. In addition, for example, in the case of the notable circumstances, the image capturing device 1201 may generate the scalable encoded data (BL+EL) 1221 of the base layer having a large amount of data at high quality and supply the data to the scalable encoded data storage device 1202.

Although the monitoring camera has been described above as the example, the usage of the image capturing system 1200 is optional and is not limited to the monitoring camera.

In addition, as the present technology is applied to the image capturing system 1200 described above in the same manner as the application to the hierarchical encoding and hierarchical decoding described above in the first and second embodiments, the same effects as those of the first and second embodiments can be obtained.

Further, the present technology can also be applied to HTTP streaming such as MPEG-DASH in which appropriate encoded data is selected in units of segments from among a plurality of pieces of encoded data having different solutions that are prepared in advance and used. In other words, a plurality of pieces of encoded data can share information related to encoding or decoding.

Further, in this specification, the example in which various kinds of information are multiplexed into an encoded stream and transmitted from the encoding side to the decoding side has been described. However, a technique of transmitting the information is not limited to this example. For example, the information may be transmitted or recorded as individual data associated with an encoded bitstream without being multiplexed in the encoded stream. Here, the term “associate” refers to that an image included in the bitstream (which may be part of an image such a slice or a block) and information corresponding to the image is configured to be linked at the time of decoding. That is, the information may be transmitted on a separate transmission path from an image (or bitstream). In addition, the information may be recorded on a separate recording medium (or a separate recording area of the same recording medium) from the image (or bitstream). Further, the information and the image (or the bitstream), for example, may be associated with each other in an arbitrary unit such as a plurality of frames, one frame, or a portion within the frame.

The preferred embodiments of the present disclosure have been described above with reference to the accompanying drawings, whilst the present invention is not limited to the above examples, of course. A person skilled in the art may find various alterations and modifications within the scope of the appended claims, and it should be understood that they will naturally come under the technical scope of the present disclosure.

Additionally, the present technology may also be configured as below.

(1)

An image processing device including:

a receiving section configured to receive hierarchical image encoded data in which image data that is hierarchized into a plurality of layers is encoded;

a pixel filling section configured to fill, with a pixel of a base layer, an unavailable peripheral pixel positioned in a periphery of a current block that is used in intra prediction to be performed when an enhancement layer of the hierarchical image encoded data is decoded;

an intra prediction section configured to perform intra prediction on the current block to generate a predictive image of the current block using the peripheral pixel that is filled with the pixel of the base layer by the pixel filling section when necessary; and

a decoding section configured to decode the enhancement layer of the hierarchical image encoded data received by the receiving section using the predictive image generated by the intra prediction section.

(2)

The image processing device according to any one of (1) and (3) to (9), wherein the pixel filling section performs filling with a pixel of the base layer that is at a position corresponding to the unavailable peripheral pixel.

(3)

The image processing device according to any one of (1), (2), and (4) to (9), further including:

a determination section configured to determine availability of a peripheral pixel of the current block of the enhancement layer,

wherein, when the determination section determines that there is an unavailable peripheral pixel, the pixel filling section performs filling with the pixel of the base layer that is at the position corresponding to the unavailable peripheral pixel.

(4)

The image processing device according to any one of (1) to (3) and (5) to (9), further including:

an up-sampling section configured to perform an up-sampling process on the pixel of the base layer according to a resolution ratio between the base layer and the enhancement layer,

wherein the pixel filling section performs filling with the pixel of the base layer that has undergone the up-sampling process by the up-sampling section.

(5)

The image processing device according to any one of (1) to (4) and (6) to (9),

wherein the receiving section further receives constrained intra control information for controlling whether or not constrained intra is to he used, and

wherein the pixel filling section performs filling with the pixel only when the constrained intra is set to be used based on the constrained intra control information received by the receiving section.

(6)

The image processing device according to any one of (1) to (5) and (7) to (9), wherein the constrained intra control information is transmitted in a picture parameter set (PPS).

(7)

The image processing device according to any one of (1) to (6), (8), and (9),

wherein the receiving section further receives base layer pixel tilling control information for controlling filling with the pixel of the base layer that is transmitted when the constrained intra is set to he used based on the constrained intra control information, and

wherein the pixel filling section performs filling with the pixel of the base layer when filling with the pixel of the base layer is allowed based on the base layer pixel filling control information that is received by the receiving section, and performs tilling with a pixel of the enhancement layer when filling with the pixel of the base layer is not allowed.

(8)

The image processing device according to any one of (1) to (7) and (9), wherein the base layer pixel filling control information is transmitted in a picture parameter set (PPS).

(9)

The image processing device according to any one of (1) to (8), wherein the decoding section further decodes the base layer of the hierarchical image encoded data that is encoded in an encoding scheme different from an encoding scheme of the enhancement layer.

(10)

An image processing method including:

receiving hierarchical image encoded data in which image data that is hierarchized into a plurality of layers is encoded;

filling, with a pixel of a base layer, an unavailable peripheral pixel positioned in a periphery of a current block that is used in intra prediction to be performed when an enhancement layer of the hierarchical image encoded data is decoded;

performing intra prediction on the current block to generate a predictive image of the current block using the peripheral pixel that is filled with the pixel of the base layer when necessary; and

decoding the enhancement layer of the received hierarchical image encoded data using the generated predictive image.

(11)

An image processing device including:

a pixel filling section configured to fill, with a pixel of a base layer, an unavailable peripheral pixel positioned in a periphery of a current block that is used in intra prediction to be performed when an enhancement layer of image data that is hierarchized into a plurality of layers is encoded;

an intra prediction section configured to perform intra prediction on the current block to generate a predictive image of the current block using the peripheral pixel that is filled with the pixel of the base layer by the pixel filling section when necessary;

an encoding section configured to encode the enhancement layer of the image data that is hierarchized into the plurality of layers using the predictive image generated by the intra prediction section; and

a transmitting section configured to transmit hierarchical image encoded data obtained by the encoding section encoding the image data that is hierarchized into the plurality of layers.

(12)

The image processing device according to any one of (11) and (13) to (19), wherein the pixel filling section performs filling with a pixel of the base layer that is at a position corresponding to the unavailable peripheral pixel.

(13)

The image processing device according to any one of (11), (12), and (14) to (19), further including:

a determination section configured to determine availability of a peripheral pixel of the current block of the enhancement layer,

wherein, when the determination section determines that there is an unavailable peripheral pixel, the pixel filling section performs filling with the pixel of the base layer that is at the position corresponding to the unavailable peripheral pixel.

(14)

The image processing device according to any one of (11) to (13) and (15) to (19), further including:

an up-sampling section configured to perform an up-sampling process on the pixel of the base layer according to a resolution ratio between the base layer and the enhancement layer,

wherein the pixel filling section performs filling with the pixel of the base layer that has undergone the up-sampling process by the up-sampling section.

(15)

The image processing device according to any one of (11) to (14) and (16) to (19), further including:

a constrained intra control information setting section configured to set constrained intra control information for controlling whether or not constrained intra is to be used,

wherein the pixel filling section performs filling with the pixel only when the constrained intra is set to be used based on the constrained intra control information set by the constrained intra control information setting section, and

wherein the transmitting section further transmits the constrained intra control information set by the constrained intra control information setting section.

(16)

The image processing device according to any one of (11) to (15) and (17) to (19), wherein the transmitting section transmits the constrained intra control information in a picture parameter set (PPS).

(17)

The image processing device according to any one of (11) to (16), (18), and (19), further including:

a base layer pixel filling control information setting section configured to set base layer pixel filling control information for controlling filling with the pixel of the base layer when the constrained intra is set to be used based on the constrained intra control information,

wherein the pixel filling section performs filling with the pixel of the base layer when filling with the pixel of the base layer is allowed based on the base layer pixel filling control information set by the base layer pixel filling control information setting section, and performs filling with a pixel of the enhancement layer when filling with the pixel of the base layer is not allowed, and

wherein the transmitting section further transmits the base layer pixel filling control information set by the base layer pixel filling control information setting section.

(18)

The image processing device according to any one of (11) to (17) and (19), wherein the transmitting section transmits the base layer pixel filling control information in a picture parameter set (PPS).

(19)

The image processing device according to any one of (11) to (18), wherein the encoding section further encodes the base layer of the hierarchical image encoded data in an encoding scheme different from an encoding scheme of the enhancement layer.

(20)

An image processing method including:

filling, with a pixel of a base layer, an unavailable peripheral pixel positioned in a periphery of a current block that is used in intra prediction to be performed when an enhancement layer of image data that is hierarchized into a plurality of layers is encoded;

performing intra prediction on the current block to generate a predictive image of the current block using the peripheral pixel that is filled with the pixel of the base layer when necessary;

encoding the enhancement layer of the image data that is hierarchized into the plurality of layers using the generated predictive image; and

transmitting hierarchical image encoded data obtained by encoding the image data that is hierarchized into the plurality of layers.

### REFERENCE SIGNS LIST

100 scalable encoding device
101 common information generation section
102 encoding control section
103 base layer image encoding section
104 pixel filling section
105 enhancement layer image encoding section
116 lossless encoding section
122 frame memory
134 intra prediction section
151 up-sampling section
152 base layer pixel memory
153 pixel filling control information setting section
154 availability determination section
155 filling pixel generation section
161 up-sampling ratio setting section
162 decoded image buffer
163 filtering section
171 Constrained_ipred setting section
172 base layer pixel filling control information setting section
200 scalable decoding device
201 common information acquisition section
202 decoding control section
203 base layer image decoding section
204 pixel filling section
205 enhancement layer image decoding section
212 lossless decoding section
219 frame memory
231 intra prediction section
251 up-sampling section
252 base layer pixel memory
253 pixel filling control information decoding section
254 availability determination section
255 filling pixel generation section
261 up-sampling ratio setting section
262 decoded image buffer section
263 filtering section
271 Constrained_ipred decoding section
272 base layer pixel filling control information decoding section

1. An image processing device comprising:
a receiving section configured to receive hierarchical image encoded data in which image data that is hierarchized into a plurality of layers is encoded;
a pixel filling section configured to fill, with a pixel of a base layer, an unavailable peripheral pixel positioned in a periphery of a current block that is used in intra prediction to be performed when an enhancement layer of the hierarchical image encoded data is decoded;
an intra prediction section configured to perform intra prediction on the current block to generate a predictive image of the current block using the peripheral pixel that is tilled with the pixel of the base layer by the pixel filling section when necessary; and
a decoding section configured to decode the enhancement layer of the hierarchical image encoded data received by the receiving section using the predictive image generated by the intra prediction section.

2. The image processing device according to claim 1, wherein the pixel filling section performs filling with a pixel of the base layer that is at a position corresponding to the unavailable peripheral pixel.

3. The image processing device according to claim 2, further comprising:
a determination section configured to determine availability of a peripheral pixel of the current block of the enhancement layer,
wherein, when the determination section determines that there is an unavailable peripheral pixel, the pixel filling section performs filling with the pixel of the base layer that is at the position corresponding to the unavailable peripheral pixel.

4. The image processing device according to claim 3, further comprising:
an up-sampling section configured to perform an up-sampling process on the pixel of the base layer according to a resolution ratio between the base layer and the enhancement layer,
wherein the pixel filling section performs filling with the pixel of the base layer that has undergone the up-sampling process by the up-sampling section.

5. The image processing device according to claim 1,
wherein the receiving section further receives constrained intra control information for controlling whether or not constrained intra is to be used, and
wherein the pixel filling section performs filling with the pixel only when the constrained intra is set to be used based on the constrained intra control information received by the receiving section.

6. The image processing device according to claim 5, wherein the constrained intra control information is transmitted in a picture parameter set (PPS).

7. The image processing device according to claim 5,
wherein the receiving section further receives base layer pixel filling control information for controlling filling with the pixel of the base layer that is transmitted when the constrained intra is set to be used based on the constrained intra control information, and
wherein the pixel filling section performs filling with the pixel of the base layer when filling with the pixel of the base layer is allowed based on the base layer pixel filling control information that is received by the receiving section, and performs filling with a pixel of the enhancement layer when filling with the pixel of the base layer is not allowed.

8. The image processing device according to claim 7, wherein the base layer pixel filling control information is transmitted in a picture parameter set (PPS).

9. The image processing device according to claim 1, wherein the decoding section further decodes the base layer of the hierarchical image encoded data that is encoded in an encoding scheme different from an encoding scheme of the enhancement layer.

10. An image processing method comprising:
receiving hierarchical image encoded data in which image data that is hierarchized into a plurality of layers is encoded;
filling, with a pixel of a base layer, an unavailable peripheral pixel positioned in a periphery of a current block that is used in intra prediction to be performed when an enhancement layer of the hierarchical image encoded data is decoded;
performing intra prediction on the current block to generate a predictive image of the current block using the peripheral pixel that is filled with the pixel of the base layer when necessary; and
decoding the enhancement layer of the received hierarchical image encoded data using the generated predictive image.

11. An image processing device comprising:
a pixel filling section configured to fill, with a pixel of a base layer, an unavailable peripheral pixel positioned in a periphery of a current block that is used in intra prediction to he performed when an enhancement layer of image data that is hierarchized into a plurality of layers is encoded;
an intra prediction section configured to perform intra prediction on the current block to generate a predictive image of the current block using the peripheral pixel that is filled with the pixel of the base layer by the pixel filling section when necessary;
an encoding section configured to encode the enhancement layer of the image data that is hierarchized into the plurality of layers using the predictive image generated by the intra prediction section; and
a transmitting section configured to transmit hierarchical image encoded data obtained by the encoding section encoding the image data that is hierarchized into the plurality of layers.

12. The image processing device according to claim 11, wherein the pixel tilling section performs filling with a pixel of the base layer that is at a position corresponding to the unavailable peripheral pixel.

13. The image processing device according to claim 12, further comprising:
a determination section configured to determine availability of a peripheral pixel of the current block of the enhancement layer,
wherein, when the determination section determines that there is an unavailable peripheral pixel, the pixel filling section performs filling with the pixel of the base layer that is at the position corresponding to the unavailable peripheral pixel.

14. The image processing device according to claim 13, further comprising:
an up-sampling section configured to perform an up-sampling process on the pixel of the base layer according to a resolution ratio between the base layer and the enhancement layer,
wherein the pixel filling section performs filling with the pixel of the base layer that has undergone t up-sampling process by the up-sampling section.

15. The image processing device according to claim 11, further comprising:
a constrained intra control information setting section configured to set constrained intra control information for controlling whether or not constrained intra is to be used,
wherein the pixel filling section performs filling with the pixel only when the constrained intra is set to be used based on the constrained intra control information set by the constrained intra control information setting section, and
wherein the transmitting section further transmits the constrained intra control information set by the constrained intra control information setting section.

16. The image processing device according to claim 15, wherein the transmitting section transmits the constrained intra control information in a picture parameter set (PPS).

17. The image processing device according to claim 15, further comprising:
a base layer pixel filling control information setting section configured to set base layer pixel filling control information for controlling filling with the pixel of the base layer when the constrained intra is set to be used based on the constrained intra control information,
wherein the pixel filling section performs filling with the pixel of the base layer when filling with the pixel of the base layer is allowed based on the base layer pixel filling control information set by the base layer pixel filling control information setting section, and performs filling with a pixel of the enhancement layer when filling with the pixel of the base layer is not allowed, and
wherein the transmitting section further transmits the base layer pixel filling control information set by the base layer pixel filling control information setting section.

18. The image processing device according to claim 17, wherein the transmitting section transmits the base layer pixel filling control information in a picture parameter set (PPS).

19. The image processing device according to claim 11, wherein the encoding section further encodes the base layer of the hierarchical image encoded data in an encoding scheme different from an encoding scheme of the enhancement layer.

20. An image processing method comprising:
filling, with a pixel of a base layer, an unavailable peripheral pixel positioned in a periphery of a current block that is used in intra prediction to be performed when an enhancement layer of image data that is hierarchized into a plurality of layers is encoded;
performing intra prediction on the current block to generate a predictive image of the current block using the peripheral pixel that is filled with the pixel of the base layer when necessary;
encoding the enhancement layer of the image data that is hierarchized into the plurality of layers using the generated predictive image; and
transmitting hierarchical image encoded data obtained by encoding the image data that is hierarchized into the plurality of layers.
